(19) United States
(12) Patent Application Publication
(10) Pub. No.: US 2009/0110313 A1
(43) Pub. Date: Apr. 30, 2009

(54) DEVICE FOR PERFORMING IMAGE PROCESSING BASED ON IMAGE ATTRIBUTE

(75) Inventor: Tsutomu Sakaue, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 12/255,334

(22) Filed: Oct. 21, 2008

(30) Foreign Application Priority Data
Oct. 25, 2007 (JP) 2007-277586
May 21, 2008 (JP) 2008-133438

(51) Int. Cl. G06K 9/54

(52) U.S. Cl. 382/243

(57) ABSTRACT

The present invention provides an image processing device able to compress the information volume of attribute data by vectorizing the attribute data. A transmitting image processing device includes an attribute separating unit that extracts attribute data from image data, a vectorization processing unit that vectorizes the attribute data extracted by the attribute separating unit, and a transmission unit that transmits, to another device, the vectorized attribute data that was vectorized by the vectorization processing unit together with the image data. A receiving image processing device includes a receiving unit that receives the image data and the vectorized attribute data that was obtained by vectorizing the original attribute data, as well as a RIP unit that restores attribute data from the vectorized attribute data in order to accurately restore the attribute data that was vectorized.

### BACKGROUND OF THE INVENTION

1. Field of the Invention

The present invention relates to an image processing device and an imaging processing method for performing image processing based on attribute of an image, as well as a computer-readable medium for performing the image processing method.

2. Description of the Related Art

In recent years, along with the spread of technologies such as intranets and the Internet, it is becoming typical to use image processing devices in an office over a network. For this reason, whereas image processing devices for producing copies have been used as stand-alone devices, it has now become possible to use such devices over a network. In other words, it has become possible to produce copies using different image processing devices over a network (see Japanese Patent Laid-Open No. 2004-274632, for example).

In the technology of the related art as disclosed in Japanese Patent Laid-Open No. 2004-274632, predetermined attribute data is generated from input image data, and the resulting attribute data is then converted into rectangle information. By converting the data in this way, the data size of the attribute information is reduced. Subsequently, the rectangle information is appended to the image data as tags and transmitted to another device. However, Japanese Patent Laid-Open No. 2004-274632 does not specify how the other device is to use the rectangle information received as tags, and thus there is a problem in that the received rectangle information seems to be meaningless.

### SUMMARY OF THE INVENTION

An image processing device according to an embodiment of the present invention is provided with: an attribute separating component configured to extract attribute data from image data; a vectorization processing component configured to perform vectorization for the attribute data extracted by the attribute separating component; and a transmitting component configured to transmit, to another device, vectorized attribute data that has been vectorized by the vectorization processing component together with the image data.

An image processing device according to an embodiment of the present invention may also be provided with: an attribute separating component configured to generate attribute data from input image data; an input image processing component configured to adaptively process input image data on the basis of attribute data generated by the attribute separating component; and a vectorization processing component configured to perform vectorization for the attribute data generated by the attribute separating component; wherein, when generating a file for transmission and attribute data of the file using post-input image processing image data generated by the input image processing component and vectorized attribute data generated by the vectorization processing component, the attributes of the vectorized attribute data are preferentially taken to be the attribute data for the file for transmission.

An image processing device according to an embodiment of the present invention may also be provided with: a receiving component configured to receive image data and vectorized attribute data obtained by performing vectorization for original attribute data; and a raster image processor configured to restore attribute data from the vectorized attribute data in order to accurately restore the vectorized attribute data.

An image processing method according to an embodiment of the present invention includes the steps of: separating attribute by extracting attribute data from image data; vectorizing the attribute data extracted in the separating step; and transmitting, to another device, the vectorized attribute data vectorized in the vectorizing step together with image data.

An image processing method according to an embodiment of the present invention may also include the steps of: separating attribute by generating attribute data from input image data; adaptively processing the input image data on the basis of attribute data generated in the separating step; and vectorizing the attribute data generated in the separating step; wherein, when generating a file for transmission and attribute data of the file using post-input image processing image data processed in the processing step and vectorized attribute data generated in the vectorizing step, the attribute of the vectorized attribute data are preferentially taken to be the attribute data for the file for transmission.

An image processing method according to an embodiment of the present invention may also include the steps of: receiving image data and vectorized attribute data obtained by performing vectorization for original attribute data; and raster image processing to restore attribute from the vectorized attribute data in order to accurately restore the vectorized attribute data.

An image processing device according to an embodiment of the present invention may also be provided with: a receiving component configured to receive image data and attribute data of reduced data size that was obtained from original attribute data; and a logical product component configured to take the logical product between the image data and the attribute data of reduced data size in order to restore the original attribute data.

In the present invention, the transmitting image processing device does not send attribute data as-is. Instead, attribute data is converted into vector data (i.e., vectorized attribute data) and then sent. The receiving image processing device then restores the attribute data from the received vector data. According to the present invention, the information volume of attribute data can be compressed, and low disk space issues that may occur when sending or receiving can be avoided. Furthermore, by having the vectorized attribute data be processed by an RIP (Raster Image Processor) in the receiving image processing device, the original attribute data can be accurately restored.

Further features of the present invention will become apparent from the following description of exemplary embodiments (with reference to the attached drawings).

### BRIEF DESCRIPTION OF THE DRAWINGS

FIG. 1 is a block diagram illustrating an exemplary configuration of an image processing device;

FIG. 2 is a flowchart illustrating a process flow performed by an attribute separating processing unit;

FIG. 3 is a block diagram illustrating an exemplary configuration of an edge determining unit 205;

FIG. 4 is a diagram illustrating an exemplary configuration of a system wherein image reproduction is realized by means of an image processing device 1 and an image processing device 2 connected by a network;

FIG. 5 is a block diagram illustrating an exemplary configuration of a system according to a first embodiment of the present invention;

FIG. 6 is a block diagram illustrating an exemplary configuration of a system according to a first embodiment of the present invention;

FIG. 7 is a block diagram illustrating an exemplary configuration of a system according to a second embodiment of the present invention;

FIG. 8 is a flowchart illustrating an exemplary process flow whereby a vectorization processing unit converts attribute data into vectorized attribute data;

FIG. 9 is a flowchart illustrating an exemplary process flow whereby a RIP converts vectorized attribute data into raster data;

FIG. 10 is a flowchart illustrating a process flow performed by an attribute substitution unit/PDF generator;

FIG. 11 is a diagram for explaining the processing performed by an attribute substitution unit/PDF generator;

FIG. 12 is a conceptual diagram illustrating attribute data;

FIG. 13 is a block diagram illustrating an exemplary configuration of a system according to a third embodiment of the present invention;

FIG. 14 is a block diagram illustrating an example of a general image processing configuration;

FIG. 15 is a block diagram illustrating an example of attribute separating processing in a general image processing configuration;

FIG. 16 is a block diagram illustrating an example of attribute separating processing in a general image processing configuration;

FIG. 17 is a block diagram illustrating an example of a processing configuration of the related art;

FIG. 18 is a block diagram illustrating an exemplary configuration of a system according to a fourth embodiment of the present invention;

FIG. 19 is a diagram explaining image data and attribute data as applied to the present invention;

FIG. 20 is a diagram explaining the generation of rectangle attribute data as applied to the present invention;

FIG. 21 is a diagram explaining the generation of rectangle attribute data as applied to the present invention;

FIG. 22 is a diagram explaining the generation of rectangle attribute data as applied to the present invention;

FIG. 23 is a block diagram of binarization processing performed as part of attribute data restoration processing as applied to the present invention;

FIG. 24 is a block diagram of binarization processing performed as part of attribute data restoration processing as applied to the present invention; and

FIG. 25 is a block diagram of binarization processing performed as part of attribute data restoration processing as applied to the present invention.

### DESCRIPTION OF THE EMBODIMENTS

Hereinafter, preferred embodiments of the invention will be described in detail with reference to the accompanying drawings. However, it should be appreciated that the elements described for the following embodiments are given only by way of example, and are not intended to limit the scope of the invention.

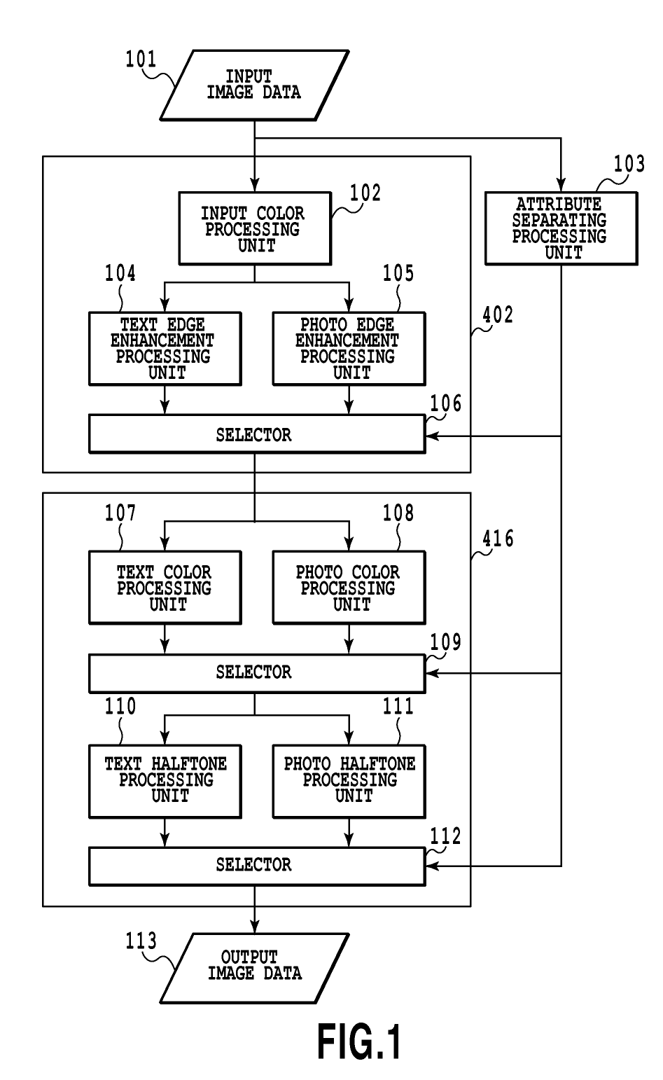

FIG. 1 is a block diagram illustrating an exemplary configuration of an image processing device.

The image processing device is provided with an input image processing unit 402, an output image processing unit 416, and an attribute separating processing unit 103. The image processing device converts input image data 101 received from a scanner (not shown in the drawings) into output image data 113, and then outputs the output image data 113 to a print engine (not shown in the drawings).

First, the configuration and operation of the input image processing unit 402 will be described.

The input image processing unit 402 includes an input color processing unit 102, a text edge enhancement processing unit 104, a photo (i.e., non-text) edge enhancement processing unit 105, and a selector 106. The input image processing unit 402 adaptively processes input image data on the basis of attribute data generated by the attribute separating processing unit 103 to be hereinafter described.

The attribute separating processing unit 103 analyzes input image data 101 received from the scanner, makes determinations for each pixel regarding whether an individual pixel exists in a text region or a photo region, and subsequently generates either text attribute data or photo attribute data. By performing attribute separating processing, it becomes possible to perform image processing for photos with respect to the pixels having photo attribute data, while also performing image processing image processing for text with respect to the pixels having text attribute data. The details of this attribute separating processing will be described later.

Herein, attribute data refers to data expressing pixel information. This pixel information does not contain information related to luminance or color tone, such as pixel luminance or density. Rather, attribute data represents pixel information other than pixel information related to luminance or color tone. Herein, the attribute data contains pixel information indicating whether individual pixels are included in a text region or a photo region, but the attribute data is not limited thereto. For example, the attribute data may also contain pixel information indicating whether or not individual pixels are included in an edge region.

The input color processing unit 102 performs image processing such as tone correction and color space conversion with respect to the input image data 101. The input color processing unit 102 then outputs processed image data to the text edge enhancement processing unit 104 and the photo edge enhancement processing unit 105.

The text edge enhancement processing unit 104 performs text edge enhancement processing with respect to the entirety of the received image data, and then outputs the text edge-enhanced image data to the selector 106. Meanwhile, the photo edge enhancement processing unit 105 performs photo edge enhancement processing with respect to the entirety of the received image data, and then outputs the photo edge-enhanced image data to the selector 106. Herein, an edge refers to a boundary portion separating a bright region and a dark region in an image, while edge enhancement refers to processing that makes the pixel density gradient steeper at such boundary portions, thereby sharpening the image.

The selector 106 also receives attribute data (i.e., text attribute data or photo attribute data) from the attribute separating processing unit 103. In accordance with the gradient data, the selector 106 selects either the text edge-enhanced image data or the photo edge-enhanced image data on a per-pixel basis. Subsequently, the selector 106 outputs the selected image data to the output image processing unit 416. In other words, when the attribute data for a given pixel is text attribute data, the selector 106 outputs to the output image processing unit 416 the pixel value of the given pixel that was contained in the image data received from the text edge enhancement processing unit 104. Meanwhile, when the attribute data for a given pixel is photo attribute data, the selector 106 outputs to the output image processing unit 416 the pixel value of the given pixel that was contained in the image data received from the photo edge enhancement processing unit 105.

The selector 106 may also perform a well-known image processing such as background removal and logarithmic conversion with respect to the received data.

In the above configuration, there are provided two components for edge enhancement (i.e., the text edge enhancement processing unit 104 and the photo edge enhancement processing unit 105), as well as a selector 106. However, the present embodiment is not limited to the above configuration. For example, instead of the above, an image processing device may also be configured having a single edge enhancement processing unit. In this case, the single edge enhancement processing unit may receive attribute data from the attribute separating processing unit 103 and then switch between filter coefficients for edge enhancement on the basis of the received attribute data.

Next, the configuration and operation of the output image processing unit 416 will be described.

The output image processing unit 416 includes a text color processing unit 107, a photo color processing unit 108, a selector 109, a text halftone processing unit 110, a photo halftone processing unit 111, and a selector 112.

The text color processing unit 107 and the photo color processing unit 108 respectively perform color processing for text and color processing for photos with respect to image data received from the input image processing unit 402. In order to improve text reproduction with an image processing device connected to a print engine having CMYK inks, the text color processing unit 107 performs color processing that causes the print engine to print text with black characters using the single color K. Conversely, the photo color processing unit 108 performs color processing emphasizing photo reproduction.

The selector 109 receives two sets of color-processed data from the text color processing unit 107 and the photo color processing unit 108. Following the attribute data (i.e., the text attribute data or the photo attribute data) received from the attribute separating processing unit 103, the selector 109 then selects either the text color-processed image data or the photo color-processed image data on a per-pixel basis. Subsequently, the selector 109 outputs the selected image data to the text halftone processing unit 110 or the photo halftone processing unit 111.

In the above configuration, there are provided two color processing unit (i.e., the text color processing unit 107 and the photo color processing unit 108) as well as a selector 106. However, the present embodiment is not limited to the above configuration. For example, instead of the above, an image processing device may be configured having a single color processing unit. In this case, the single color processing unit may appropriately select coefficients in accordance with the attribute data and then perform color processing.

The text halftone processing unit 110 and the photo halftone processing unit 111 respectively receive color-processed image data from the selector 109, respectively perform text halftone processing and photo halftone processing with respect to the received image data, and then output the resulting halftone data.

The text halftone processing unit 110 emphasizes text reproduction, and performs error diffusion processing or high screen ruling dither processing, for example. Conversely, the photo halftone processing unit 111 emphasizes smooth and stable tone reproduction for photos, and performs low screen ruling dither processing or similar halftone processing.

The selector 112 receives two sets of halftone data from the text halftone processing unit 110 and the photo halftone processing unit 111. Subsequently, on the basis of the attribute data (i.e., the text attribute data or the photo attribute data), the selector 112 selects one of the two sets of halftone data on a per-pixel basis.

In the above configuration, there are provided two halftone processing units (i.e., the text halftone processing unit 110 and the photo halftone processing unit 111), as well as a selector 112. However, the present embodiment is not limited to the above configuration. For example, instead of the above three means, an image processing device may be configured having a single halftone processing unit. In this case, the single halftone processing unit receives attribute data from the attribute separating processing unit 103 and performs halftone processing by appropriately selecting coefficients in accordance with the attribute data.

The single set of halftone data selected by the selector 112 is then output to the print engine as output image data 113, and then processed for printing by the print engine.

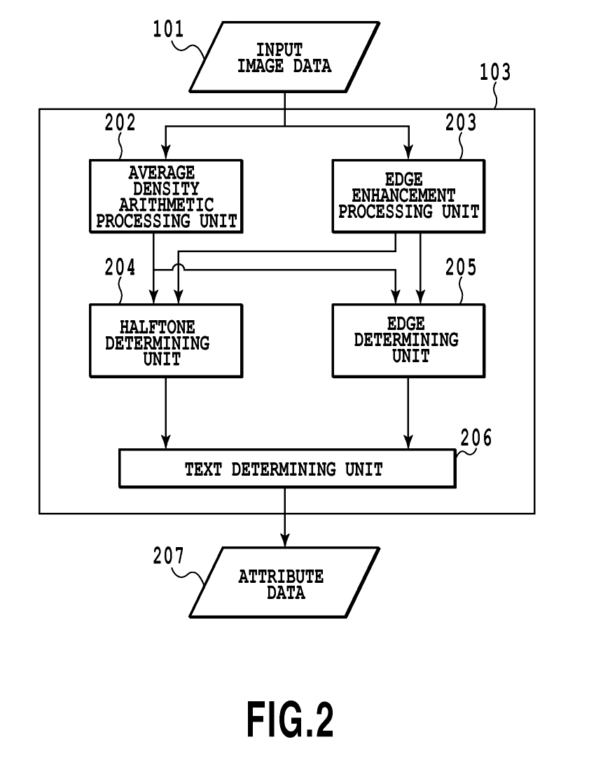

Next, the process performed by the attribute separating processing unit 103 will be described in detail and with reference to FIG. 2.

As described above, the attribute separating processing unit 103 analyzes input image data 101 received from a scanner, makes determinations for each pixel regarding whether an individual pixel exists in a text region or a photo region, and subsequently generates either text attribute data or photo attribute data.

The attribute separating processing unit 103 includes an average density arithmetic processing unit 202, an edge enhancement processing unit 203, a halftone determining unit 204, an edge determining unit 205, and a text determining unit 206.

The average density arithmetic processing unit 202 computes and outputs average density data for 5 pixel×5 pixel (totaling 25 pixels) regions in the input image data 101, for example. Meanwhile, the edge enhancement processing unit 203 performs edge enhancement processing with respect to the same 5 pixel×5 pixel (totaling 25 pixels) regions, for example, and then outputs the resulting edge-enhanced data. The filter used for edge enhancement is preferably a differential filter having spatial frequency characteristics for extracting predetermined edges.

The halftone determining unit 204 compares the average density data received from the average density arithmetic processing unit 202 to the edge-enhanced data received from the edge enhancement processing unit 203, and from the difference therebetween, determines whether or not a given region is a halftone region. Herein, in order to compare the average density data and the edge-enhanced data, the halftone determining unit 204 may respectively multiply the data by correction coefficients, or alternatively, the halftone determining unit 204 may apply an offset when comparing the difference. In so doing, the halftone determining unit 204 determines whether a given region is a halftone region, and then generates and outputs halftone data as a determination result.

The edge determining unit 205 compares the average density data received form the average density arithmetic processing unit 202 to the edge-enhanced data received from the edge enhancement processing unit 203, and from the difference therebetween, determines whether or not edges exist.

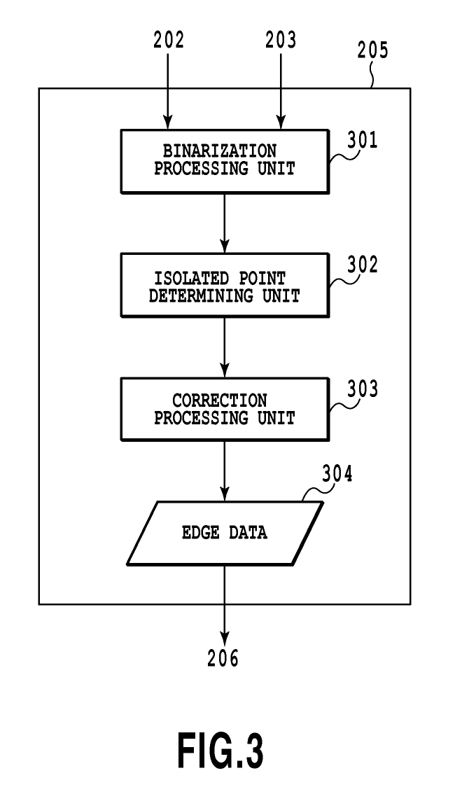

FIG. 3 is a block diagram illustrating an exemplary configuration of the edge determining unit 205.

The edge determining unit 205 includes a binarization processing unit 301, an isolated point determining unit 302, and a correction processing unit 303.

The binarization processing unit 301 compares the average density data received from the average density arithmetic processing unit 202 to the edge-enhanced data received from the edge enhancement processing unit 203, and from the difference therebetween, determines whether or not edges exist. If edges do exist, the binarization processing unit 301 generates edge data. Herein, in order to compare the average density data to the edge-enhanced data, the binarization processing unit 301 may respectively multiply the data by correction coefficients, or alternatively, the binarization processing unit 301 may apply an offset when comparing the difference. In so doing, the binarization processing unit 301 determines whether or not edges exist.

The isolated point determining unit 302 receives as input the edge data generated by the binarization processing unit 301, refers to the 5 pixel×5 pixel (totaling 25 pixels) regions constituting the edge data, for example, and then determines whether or not a given edge is an isolated point. If an edge is an isolated point, then the isolated point determining unit 302 removes the edge or integrates the edge with another edge. The above processing is performed in order to reduce edge extraction determination errors due to noise.

The correction processing unit 303 performs correction processing to thicken edges and remove unevenness from lines by correcting notches or other features with respect to the edge data from which isolated points were removed by the isolated point determining unit 302. The correction processing unit 303 thus generates and outputs corrected edge data 304.

The text determining unit 206 receives as input the halftone data generated by the halftone determining unit 204 as well as the edge data 304 generated by the edge determining unit 205.

Returning to FIG. 2, the text determining unit 206 determines an individual pixel to be part of a text edge if, for example, the pixel is not in a halftone region and additionally part of an edge. In other words, the text determining unit 206 determines text within a halftone region to be a halftone, while determining text outside a halftone region to be text. Alternatively, the text determining unit 206 may determine an individual pixel to be part of a text edge in a halftone region if the pixel is in a halftone region and additionally part of an edge. Alternatively, the text determining unit 206 may determine an individual pixel to be part of a text edge if the pixel is not in a halftone region and additionally part of an edge. Since the above processing becomes part of the internal design specification of the image processing device, the particular processing to use may be determined on the basis of the specification.

In the image processing device described above, input image data is subjected to attribute separating processing to thereby generate per-pixel attribute data (i.e., text attribute data or photo attribute data) 207, and then image processing is performed according to the attribute data 207. For example, photo regions may be processed for photos emphasizing color tone and gradation, while text regions may be processed for text emphasizing sharpness, thereby improving image quality in the reproduced image. Moreover, detecting the color components of an image and printing achromatic text or other regions using pure black allows for improvement of image quality.

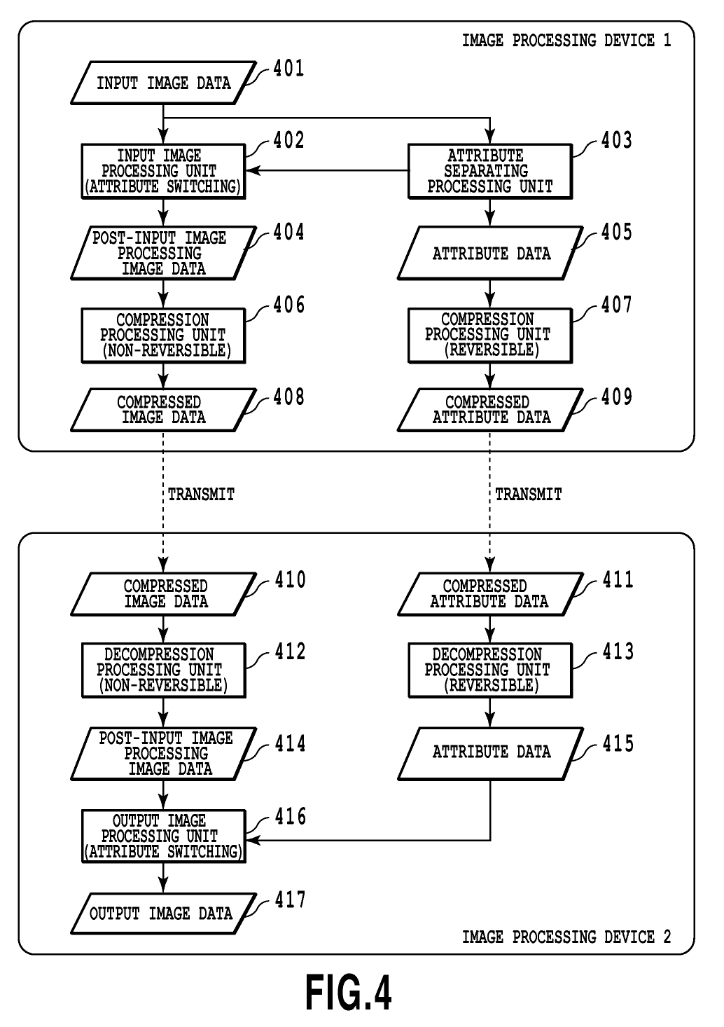

Meanwhile, when a plurality of image processing devices like the above are connected over a network and used to reproduce images, several problems arise. Such a configuration and problems will now be described with reference to FIG. 4.

FIG. 4 is a diagram illustrating an exemplary configuration of a system for realizing image reproduction by means of an image processing device 1 and an image processing device 2 connected by a network. More specifically, FIG. 4 illustrates an exemplary configuration of a system wherein the image processing device 1 transmits scanned image data to the image processing device 2, while the image processing device 2 receives the image data and prints the image data via a print engine.

The image processing device 1 performs input image processing with respect to input image data 401 obtained from a scanner, and subsequently performs attribute separating processing (i.e., the generation of attribute data) as well as compression or other processing. The image processing device 1 then transmits the resulting compressed image data 408 and compressed attribute data 409 to the image processing device 2. Meanwhile, the image processing device 2 receives compressed image data 410 and compressed attribute data 411 from the image processing device 1 and subsequently performs output image processing thereon.

First, the processing performed by the image processing device 1 will be described.

The input image processing unit 402 and the attribute separating processing unit 403 receive input image data 401 from a scanner. The attribute separating processing unit 403 corresponds to the attribute separating processing unit 103 shown in FIG. 1. In addition, the processing performed by the input image processing unit 402 and the attribute separating processing unit 403 is equivalent to the processing described with reference to FIG. 1. However, in contrast to the example shown in FIG. 1, the image processing device 1 shown in FIG. 4 is configured to transmit image data and attribute data to the image processing device 2, and thus the processing described hereinafter differs from the processing described with reference to FIG. 1.

First, the input image processing unit 402 outputs post-input image processing image data 404 to the compression processing unit 406. The post-input image processing image data 404 corresponds to the image data output by the selector 106 shown in FIG. 1. The compression processing unit 406 compresses the post-input image processing image data 404 using a well-known non-reversible compression scheme such as JPEG, thereby generating compressed image data 408.

The attribute separating processing unit 403 outputs attribute data 405 to the compression processing unit 407. The attribute data 405 corresponds to the attribute data output by the attribute separating processing unit 103 shown in FIG. 1. The compression processing unit 407 compresses the attribute data 405 using a well-known reversible compression scheme such as PackBits, thereby generating compressed attribute data 409.

In this way, the image processing device 1 respectively compresses the post-input image processing image data 404 and the attribute data 405, and then sends the results to the image processing device 2 as the compressed image data 408 and the compressed attribute data 409. The compressed image data 408 and the compressed attribute data 409 transmitted by the image processing device 1 is then received by the image processing device 2 as the compressed image data 410 and the compressed attribute data 411.

The decompression processing unit 412 in the image processing device 2 decompresses the received compressed image data 410, thereby generating post-input image processing image data 414. In addition, the decompression processing unit 413 in the image processing device 2 decompresses the received compressed attribute data 411, thereby generating attribute data 415.

The output image processing unit 416 receives the post-input image processing image data 414 and the attribute data 415. Similarly to the example shown in FIG. 1, the output image processing unit 416 processes the post-input image processing image data 414 in accordance with the attribute data 415, thereby generating output image data 417. The output image processing unit 416 corresponds to the selector 109 shown in FIG. 1.

In the above configuration, image reproduction over a network is performed as a result of scanned image data obtained at the image processing device 1 being transmitted to the image processing device 2 and then printed using a print engine connected to the image processing device 2. With this configuration, output material is obtained at the image processing device 2 that is equal in image quality to the reproduced image output by the image processing device 1. However, while the data size can be reduced by applying a non-reversible compression scheme such as JPEG to the image data, the data size increases because only a reversible compression scheme is applied to the attribute data. As a result, low disk space issues may occur on the transmitting image processing device 1 or the receiving image processing device 2. In particular, if the receiving device is unable to print immediately, it may be necessary to retain the data for a long period of time.

### First Embodiment

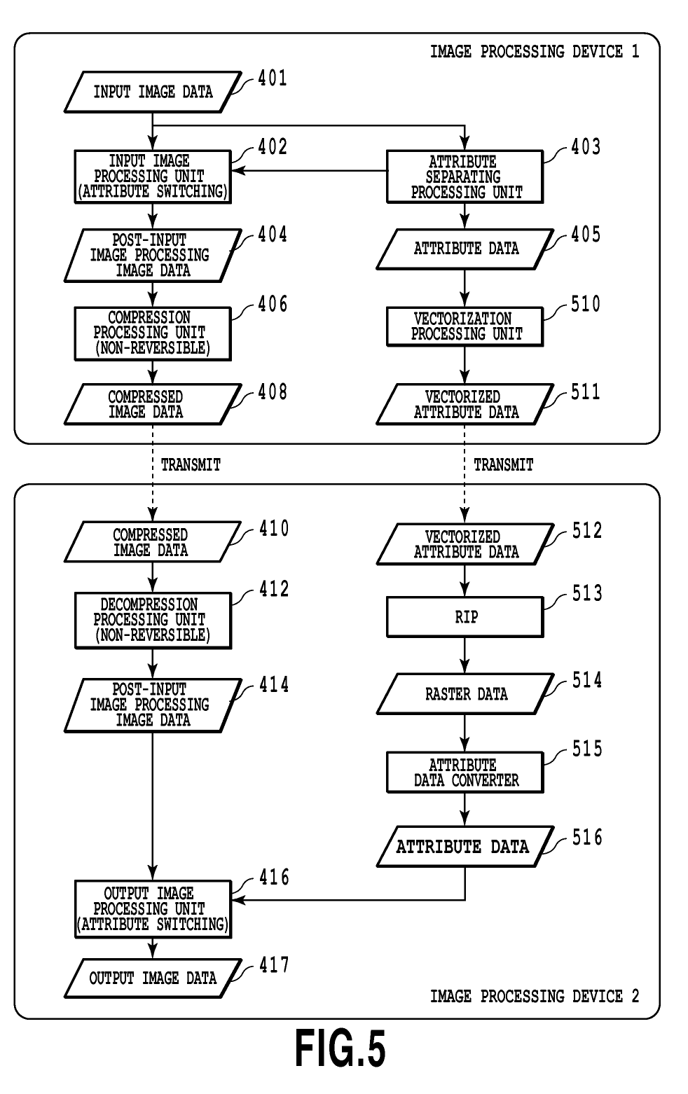

FIG. 5 is a block diagram illustrating the configuration of a system in accordance with a first embodiment of the present invention.

Comparing the configuration shown in FIG. 5 to the configuration shown in FIG. 4, it can be seen that the processing performed with respect to the image data is similar, but differing in that in the configuration shown in FIG. 5, the attribute data is also subjected to vectorization processing. Hereinafter, the vectorization processing applied to the attribute data will be described in detail.

Vectorization generally refers to converting an image in bitmap format, which defines per-pixel data, to a vector format, which displays an image by means of lines that connect two points. Editing vectorized images is simple, and a vectorized image can be converted to a bitmap image at an arbitrary resolution. Moreover, vectorizing an image also has the advantage of allowing for the information volume of the image data to be compressed.

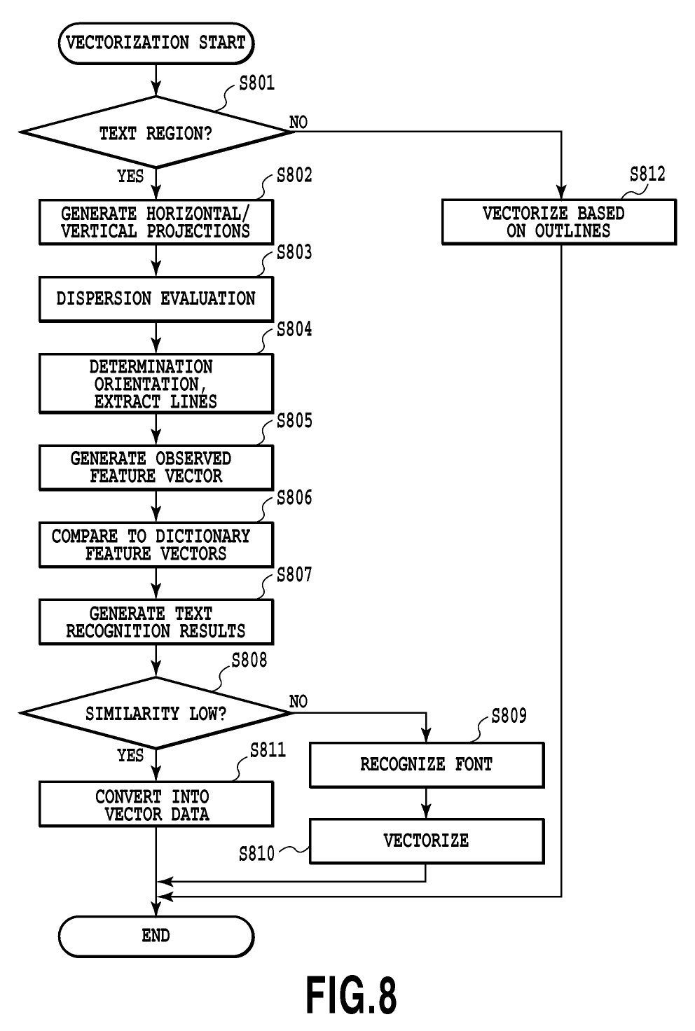

In the image processing device 1 shown in FIG. 5, the vectorization processing unit 510 converts the attribute data 405 generated by the attribute separating processing unit 403 to vectorized attribute data 511. The processing performed by the vectorization processing unit 510 will now be described with reference to FIG. 8.

FIG. 8 is a flowchart illustrating an exemplary process flow whereby the vectorization processing unit 510 converts the attribute data 405 into vectorized attribute data 511.

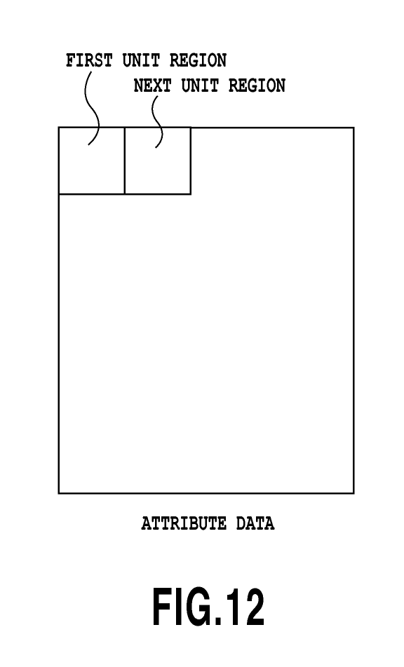

The present process is performed with respect to the attribute data on a unit region basis (1000 pixels×1000 pixels, for example; see FIG. 12). More specifically, the processing shown in FIG. 8 is performed with respect to the first unit region in the attribute data, and upon completion thereof, the processing shown in FIG. 8 is performed for the next unit region.

In step S801, the vectorization processing unit 510 determines whether or not the current unit region is a text region. If the current unit region is a text region, then the process proceeds to step S802. If the current unit region is not a text region, then the process proceeds to step S812.

In step S812, the vectorization processing unit 510 performs vectorization processing on the basis of the edges in the image when the current unit region is not a text region.

In step S802, in order to determine whether the text in the current unit region is written horizontally or vertically (i.e., the text direction), the vectorization processing unit 510 acquires horizontal and vertical projections with respect to the pixel values within the current unit region.

In step S803, the vectorization processing unit 510 evaluates the dispersion in the horizontal and vertical projections that were obtained in step S802. If the dispersion of the horizontal projection is greater, then the vectorization processing unit 510 determines the text direction to be horizontal. If the dispersion of the vertical projection is greater, then the vectorization processing unit 510 determines the text direction to be vertical.

In step S804, the vectorization processing unit 510 obtains text by decomposing the unit region into character strings and characters on the basis of the determination result that was obtained in step S803.

A horizontal text region is decomposed into character strings and characters by using the horizontal projection to extract lines, and then applying the vertical projection to the extracted lines in order to extract characters therefrom. On the other hand, a vertical text region is decomposed into character strings and characters by using the vertical projection to extract columns, and then applying the horizontal projection to the extracted columns in order to extract characters therefrom. The text size is also detectable when extracting lines, columns, and characters.

In step S805, the vectorization processing unit 510 takes the individual characters (i.e., the individual characters within the current unit region) that were extracted in step S804, and generates an observed feature vector wherein the features obtained from the text region have been converted into numerical sequences in several tens of dimensions. A variety of well-known techniques may be used as the feature vector extraction technique. For example, one method involves dividing text into meshes and then generating a feature vector having a number of dimensions equal to the mesh number and wherein the character strokes in each mesh are counted as linear elements on a per-direction basis.

In step S806, the vectorization processing unit 510 compares the observed feature vector obtained in step S805 to dictionary feature vectors determined in advance for each character in various font types. The vectorization processing unit 510 then computes the distances between the observed feature vector and the dictionary feature vectors.

In step S807, the vectorization processing unit 510 evaluates the distances computed in step S806, and takes the font type character having the shortest distance to be the recognition result.

In step S808, the vectorization processing unit 510 determines whether or not the shortest distance in the distance evaluation obtained in step S807 is greater than a predetermined distance. If the shortest distance is equal to or greater than the shortest distance, then there is a high possibility that the character is being misrecognized as another character similar in shape in the dictionary feature vector. Consequently, when the similarity is equal to or less than a predetermined value, the vectorization processing unit 510 proceeds to step S811 without adopting the recognition result obtained in step S807. In contrast, if the similarity is greater than the predetermined value, then the recognition result obtained in step S807 is adopted and the process proceeds to step S809.

In step S809, the vectorization processing unit 510 prepares a plurality of dictionary feature vectors for the font type characters to be used for character recognition to determine the character shape (i.e., the font). The vectorization processing unit 510 is thus able to recognize the character font by using pattern matching and outputting the font along with a character code.

In step S810, the vectorization processing unit 510 uses the outline data corresponding to the character and font (i.e., the character code and font information) obtained by character recognition and font recognition to convert each character into vector data.

In step S811, the vectorization processing unit 510 outlines each character, treating each character as a general line graphic. For characters having a high possibility of misrecognition, vector data is generated for an outline faithful to the visible image.

In this way, the vectorization processing unit 510 shown in FIG. 5 converts the attribute data 405 into vectorized attribute data 511. Since characters for which function approximation is performed are expressed using coordinate information in the vectorized attribute data 511, the information volume is small compared to that of the attribute data 405. Consequently, the vectorized attribute data 511 can be efficiently transmitted. In addition, there is reduced concern for low disk space issues on the receiving device. The effects are particularly large when handling data with high resolutions in the print engine. It should be appreciated that the image processing device 1 may also reversibly compress the vectorized attribute data and transmit the result as reversibly compressed, vectorized attribute data. In this case, the image processing device 2 decompresses the received reversibly compressed, vectorized attribute data, thereby generating the vectorized attribute data 512.

The image processing device 1 transmits to the image processing device 2 the compressed image data 408 and the vectorized attribute data 511 obtained by the processes described above.

Next, the exemplary configuration of the image processing device 2 shown in FIG. 5 will be described.

The image processing device 2 receives the compressed image data 408 and the vectorized attribute data 511 transmitted by the image processing device 1 as compressed image data 410 and vectorized attribute data 512.

In the image processing device 2, the decompression processing unit 412 decompresses the compressed image data 410, thereby generating post-input image processing image data 414.

Meanwhile, the RIP (Raster Image Process) 513 converts (i.e., RIP processes) the vectorized attribute data 512 into raster data (i.e., bitmap data) 514.

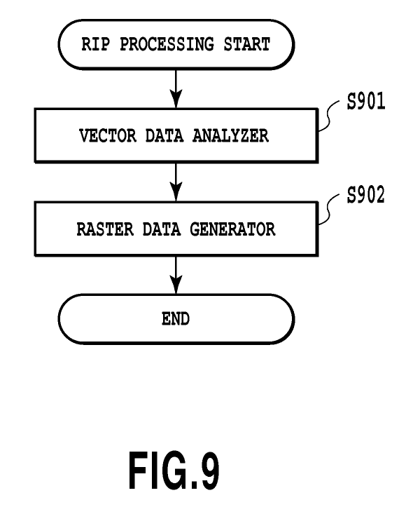

FIG. 9 is a flowchart illustrating an exemplary process flow whereby the RIP 513 converts vectorized attribute data 512 into raster data 514.

In step S901, the RIP 513 analyzes the vectorized attribute data 512. More specifically, the RIP 513 analyzes the vectorized attribute data 512 and acquires vectorized attribute data 512 in page units for pages corresponding to the compressed image data 410.

In step S902, the RIP 513 converts the vectorized attribute data 512 into raster data 514 in single page units using a well-known rasterizing technology.

As a result of the above processing, the RIP 513 converts the vectorized attribute data 512 into the raster data 514.

Next, the attribute data converter 515 converts the raster data 514 into attribute data 516. Since the raster data 514 is binary image data, the attribute data converter 515 converts the raster data 514 into attribute data 516 that can be processed by the output image processing unit 416. Since this conversion processing may also be performed simultaneously with the generation of the raster data, it is also possible to omit the above.

Finally, the output image processing unit 416 performs output image processing with respect to the post-input image processing image data 414 on the basis of the attribute data 516, thereby generating the output image data 417. It should be appreciated that the processing performed by the output image processing unit 416 shown in FIG. 5 is similar to the processing performed by the output image processing unit 416 shown in FIG. 1.

As described above, in the first embodiment, the transmitting image processing device 1 does not send attribute data as-is, but instead converts the attribute data into vector data (i.e., vectorized attribute data) before sending. Meanwhile, the receiving image processing device 2 restores the original attribute data from the received vector data (i.e., vectorized attribute data). In so doing, it becomes possible in the present embodiment to realize compression of the information volume of the attribute data, and thus avoid low disk space issues that may occur when sending and receiving data.

In the first embodiment, since the vectorized attribute data 512 is converted into the raster data 514 using RIP technology, attribute data 516 can be obtained that is an accurate restoration of the original attribute data 405. Furthermore, in the first embodiment, since accurate restoration is realized, output image data can be output that is nearly identical to the image data in the case where it is not necessary to reduce the data size of the attribute data for transmission (i.e., the case of the configuration shown in FIG. 1).

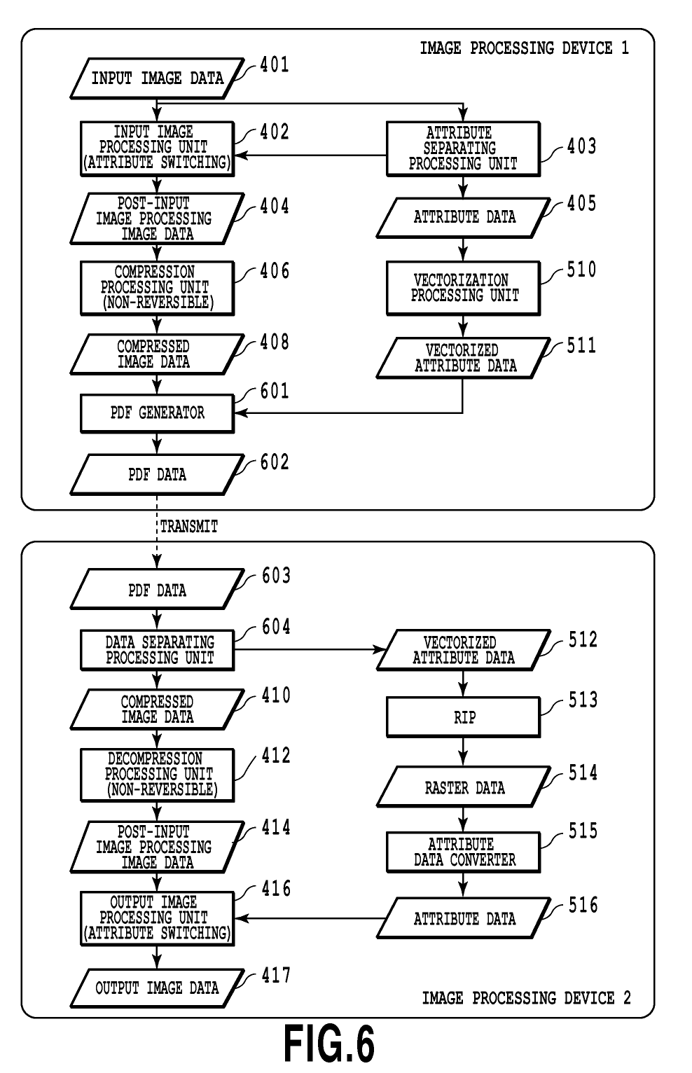

In the image processing device 1, both the compressed image data 408 and the vectorized attribute data 511 are transmitted to the image processing device 2. However, a tag information region may be provided within the compressed image data 408, and the vectorized attribute data 511 may be added in the tag information region and transmitted. Alternatively, a PDF generator 501 may be provided as shown in FIG. 6, wherein the PDF generator 501 converts the compressed image data 408 and the vectorized attribute data 511 into PDF data 602, and then transmits the PDF data 602 to the image processing device 2. In this case, upon receiving the PDF data 602, the image processing device 2 uses the data separating processing unit 604 to separate the PDF data 602 into the vectorized attribute data 512 and the compressed image data 410. Thereinafter, the processing is similar to that of the first embodiment.

### Second Embodiment

In the first embodiment, the image processing device 1 vectorizes attribute data to generate vectorized attribute data. Subsequently, the image processing device 1 transmits compressed image data and vectorized attribute data to a receiving image processing device 2. Meanwhile, the image processing device 2 restores the original attribute data from the received vectorized attribute data, and then uses the restored attribute data to control the output image processing unit 416. By configuring the first embodiment in this way, it becomes possible to improve the compression of the attribute data as well as the quality of the output image data. However, with the above configuration, the receiving image processing device 2 must be provided with an output image processing unit 416 to switch the image data according to the attribute data. Consequently, in the second embodiment, a system is provided having higher versatility than a system in accordance with the first embodiment.

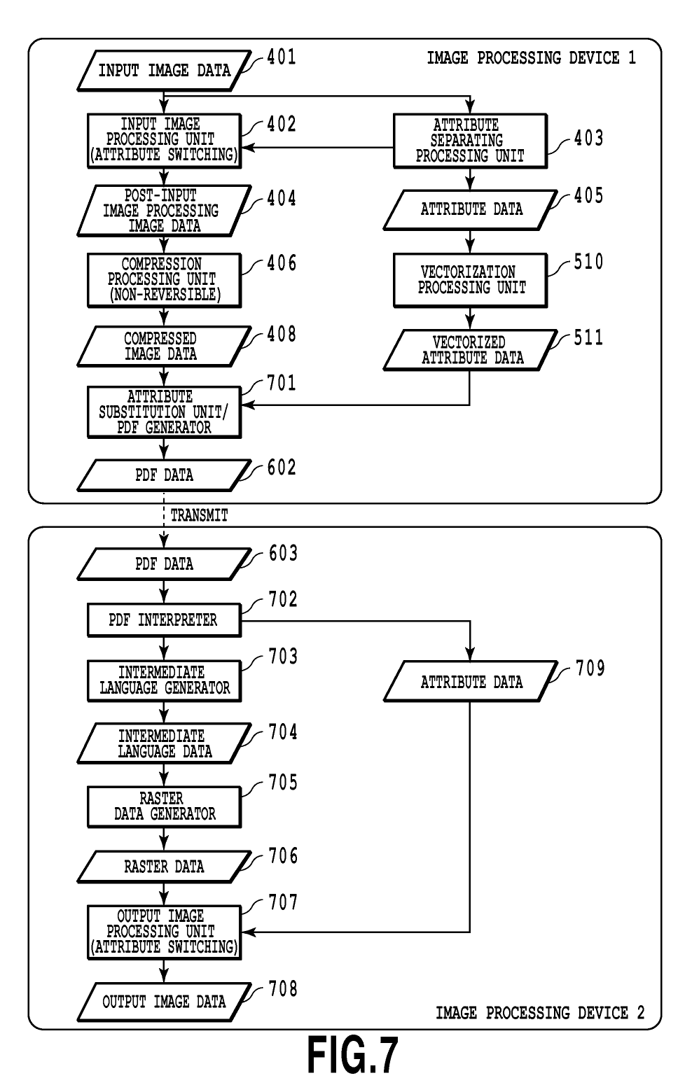

FIG. 7 is a block diagram illustrating the configuration of a system in accordance with a second embodiment of the present invention.

The configuration shown in FIG. 7 differs from the configuration shown in FIG. 6 in that the transmitting image processing device 1 is provided with an attribute substitution unit/PDF generator 701. Other features of the configuration are similar to those of the configuration shown in FIG. 6.

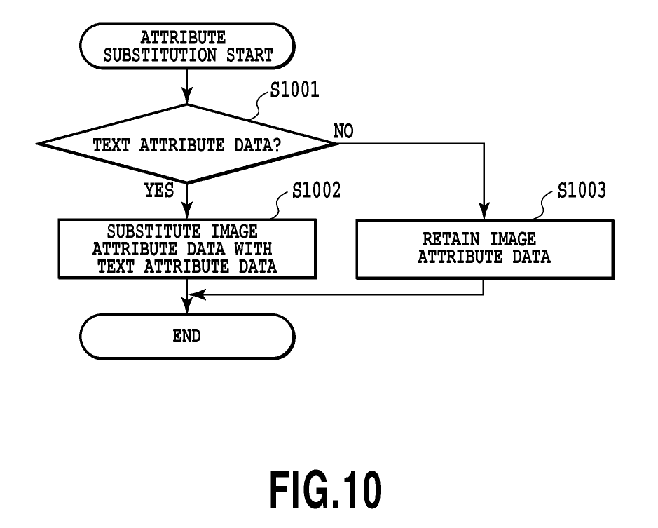

FIG. 10 is a flowchart illustrating a process flow performed by the attribute substitution unit/PDF generator 701.

In step S1001, the attribute substitution unit/PDF generator 701 determines, at the time of PDF generation, whether the vectorized attribute data 511 received from the vectorization processing unit 510 is text attribute data or image attribute data. If the vectorized attribute data 511 is determined to text attribute data, then the attribute substitution unit/PDF generator 701 proceeds to perform the processing in step S1002. If the vectorized attribute data 511 is determined to be image attribute data, then the attribute substitution unit/PDF generator 701 proceeds to perform the processing in step S1003.

In step S1002, the attribute substitution unit/PDF generator 701 substitutes the image attribute data with text attribute data.

In step S1003, the attribute substitution unit/PDF generator 701 stores the image attribute data.

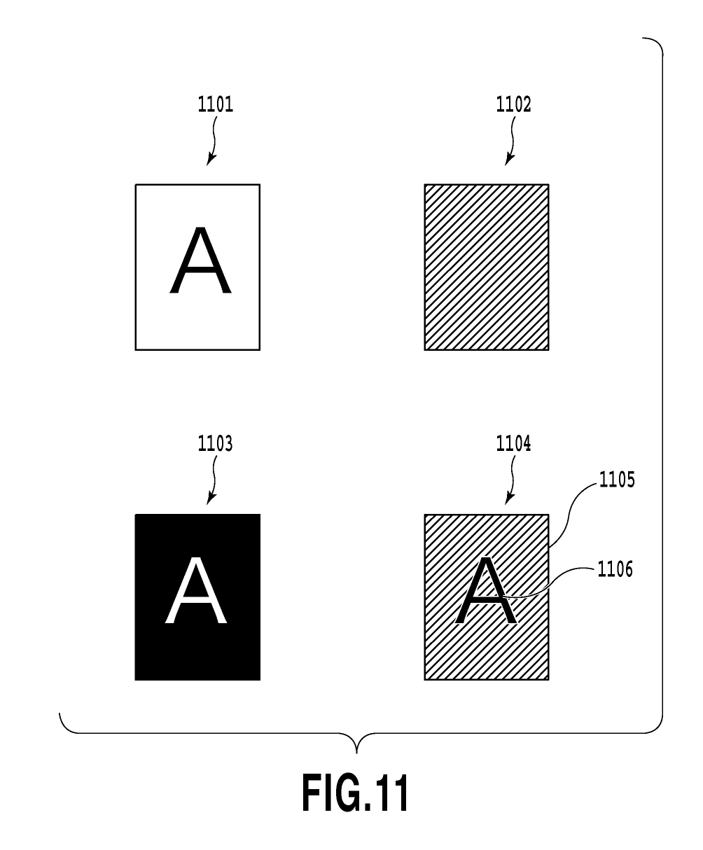

As a result of the above processing, image attribute data within a text region is substituted with text attribute data. The details of this substitution will now be described with reference to FIG. 11.

In FIG. 11, 1103 illustrates vector attribute data obtained as a result of the attribute separating processing unit 403 performing attribute separating processing with respect to a text region containing the character “A” 1101, and then vectorizing that attribute data. For convenience, in the vectorized attribute data 1103, the white portions indicate the vector attribute portion (i.e., the locations where vector attributes are valid), while the black portion indicates the locations where vector attributes are invalid. In addition, the corresponding compressed image data for the same region is an image of the entire region, and 1102 indicates the attribute data of that image. For convenience, the diagonal portions in the figure are taken to be the image attribute portions (i.e., the locations where image attributes are valid). By performing processing that follows the flowchart shown in FIG. 10, the attribute substitution unit/PDF generator 701 generates the attribute-substituted attribute data 1104 from the attribute data 1103 and 1102. In the attribute data 1104, the image attribute portions are shown by diagonal lines, while the vector attribute portions are shown as solid. In the attribute-substituted attribute data 1104, only the text region 1106 becomes vector attributes, while the remaining portion 1105 becomes image attributes.

In this way, the attribute substitution unit/PDF generator 701 generates PDF data 602 using the compressed image data 408 and the new attribute data (i.e., the attribute-substituted attribute data) generated from the vectorized attribute data 511 and the attribute data of the compressed image data 408. Normally, the attribute data of a bitmap image becomes image attribute data at the time of PDF generation. Consequently, the compressed image data image contains image attribute data for the entire image at the time of PDF generation. For this reason, in the second embodiment, attribute substitution is performed at the time of PDF generation, thereby causing the image attribute data for the text region 1106 to be substituted with vectorizable text attribute data. In other words, the second embodiment is configured such that, when generating a file for transmission and the attribute data thereof from the post-input image processing image data 404 and the vectorized attribute data, the vector attributes of the vectorized attribute data are preferentially adopted as the attribute data for the transmitted file.

Returning to FIG. 7, the image processing device 1 transmits the PDF data 602 to the image processing device 2. A PDF interpreter 702 within the image processing device 2 interprets the received PDF data 603, acquires data to be output in page units, and then outputs the data to an intermediate language generator 703 while additionally generating attribute data 709.

The intermediate language generator 703 generates intermediate language data 704 in a format that can be internally processed by the image processing device 2.

A raster data generator 705 generates raster data 706 on the basis of the generated intermediate language data 704.

An output image processing unit 707 generates output image data 708 from the generated raster data 706 on the basis of the attribute data 709, and then outputs the result to a print engine.

At this point, the output image processing unit 707, in accordance with the attribute data 709, switches the image processing for photo regions and text regions. In particular, in text regions, color processing suited to text is performed. In particular, when the text is black, printing in solid black color increases the quality of text reproduction.

In the present embodiment, when generating the attribute data for the file to be transmitted, the vectorized data is taken to include vector attributes. However, it should be appreciated that the present embodiment is not necessarily limited to the above. For example, the vectorized data may include text attributes instead of vector attributes.

As described above, by using a format such as PDF, for example, it becomes possible to perform copying over a network using a wide range of image processing rather than only specific image processing devices. In particular, by using a feature referred to as PDF Direct that provides PDF interpreting and printing functions, it becomes possible to realize network copying even when the receiving image processing device is a typical printer or similar device that does not include copy functions.

The first embodiment is configured such that a transmitting image processing device 1 vectorizes attribute data and then transmits compressed image data and vectorized attribute data to a receiving image processing device 2. The receiving image processing device 2 then receives the vectorized attribute data and restores the original attribute data therefrom. The receiving image processing device 2 then performs output image processing provided therein. As a result, image quality is improved.

In contrast, the second embodiment is configured such that the transmitting image processing device 1 first vectorizes attribute data, generates compressed image data and PDF data, and then transmits the PDF data. At this point, the image attribute data contained in the compressed image data is substituted for vectorized attribute data to generate the PDF data. The receiving image processing device 2 then performs output image processing with respect to the transmitted PDF data and in accordance with the attribute data contained in the PDF data. As a result, image quality is improved.

Current SFPs (Single-Function Printers) (i.e., printers lacking copy functions) are unable to internally restore attribute data. However, when vectorized attribute data is received along with image data in PDF format, an SFP is able to perform image processing with respect to the image data by using the vectorized attribute data. Consequently, the second embodiment is even effective in the case where printing is performed using an SFP.

### Third Embodiment

The third embodiment is configured such that the transmitting image processing device 1 determines the configuration of the receiving image processing device 2, and subsequently transmits data matching the configuration of the image processing device 2. In other words, regardless of whether the configuration of the image processing device 2 is like that described in the first embodiment or like that described in the second embodiment, the image processing device 1 identifies that configuration and subsequently transmits data matching the configuration of the image processing device 2.

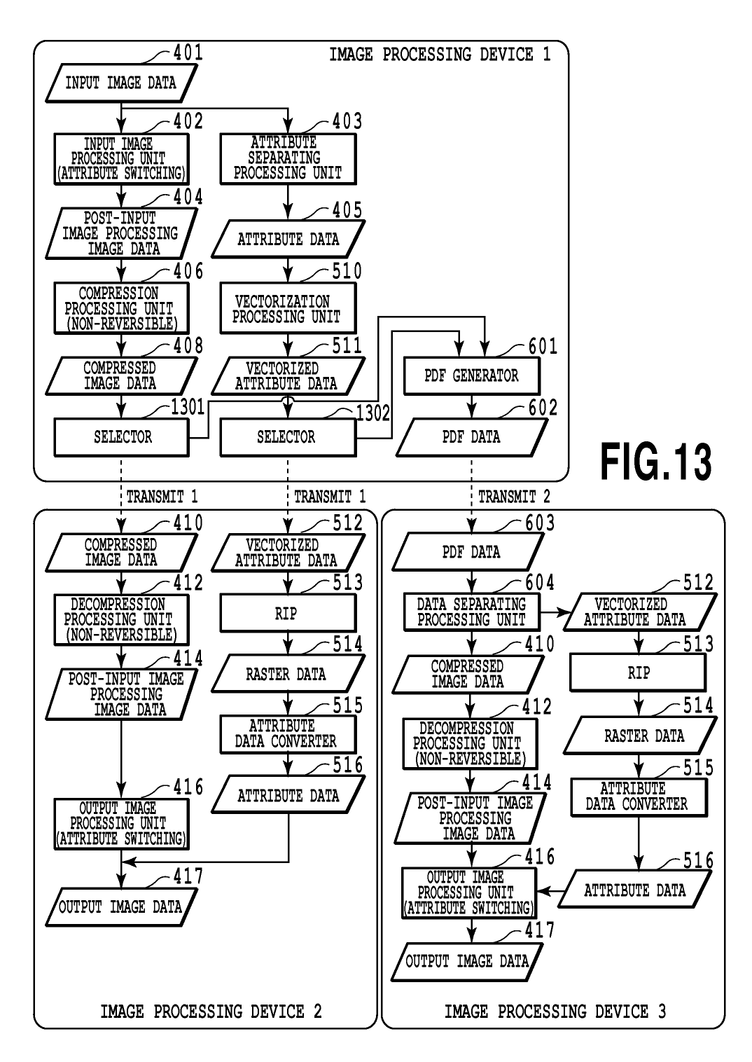

FIG. 13 is a block diagram illustrating the configuration of a system in accordance with the third embodiment of the present invention.

In FIG. 13, the processing performed by the image processing device 1 until the generation of the compressed image data 408 and the vectorized attribute data 511 is as described in the first and second embodiments. Furthermore, the PDF generator 601 is as described in the second embodiment.

The selector 1301 and the selector 1302 in FIG. 13 switch between transmission routes Transmission 1 and Transmission 2. When the user specifies an image processing device as the transmission destination using a UI not shown in the drawings, the selector 1301 and the selector 1302 select a predetermined transmission route according to the specified destination. For example, if the user selects an image processing device 2 configured as described in the first embodiment, the selectors select Transmission Route 1. On the other hand, if the user selects an image processing device (herein referred to as the image processing device 3) configured as described in the second embodiment, then the selectors select Transmission Route 2. At this point, the image processing device 1 outputs the compressed image data 408 and the vectorized attribute data 511 to the PDF generator 601. The PDF generator 601 then generates PDF data 602 using the method described in the second embodiment. Subsequently, the image processing device 1 transmits the PDF data 602 to the image processing device 3 via the route Transmission 2.

In the selection method described above, the configuration of the receiving image processing device is already known in advance, and a receiving image processing device selected by the user on the UI is associated with a transmission route. However, the present embodiment is not limited to the case wherein the receiving image processing device and the transmission route are associated. An example of the above will now be described. First, the user specifies a receiving image processing device from the UI. When the receiving image processing device is selected, the image processing device 1 communicates with the receiving image processing device and acquires image processing configuration information for the receiving device. According to this configuration, the selector 1301 and the selector 1302 switch, and the transmission data format is automatically changed. At this point, it is preferable to automatically store the configuration of the receiving image processing device to prevent re-transmission to the same image processing device. Thereinafter, it is no longer necessary to communicate with the receiving device and acquire image processing configuration information, and thus it becomes possible to transmit efficiently.

In addition, for image processing devices managed in groups by a network management application or similar means, necessary device information for image processing devices can be acquired in advance from the management software and then stored in the transmitting image processing device. In so doing, it is possible to eliminate per-transmission communication.

In the case where the receiving image processing device is able to receive a transmission via either the Transmission 1 route or the Transmission 2 route, then the system may be configured such that the user is able to select the receiving method on the transmitting image processing device.

As described above, by having the user simply select a receiving image processing device, it becomes possible for the transmitting image processing device to automatically convert data to a data format in accordance with the configuration of the receiving device, and subsequently transmit the converted data. As a result, by selecting the optimal format that matches the capabilities of the receiving image processing device, it becomes possible to realize suitable network copying.

### Fourth Embodiment

Hereinafter, a fourth embodiment will be described with reference to the accompanying drawings.

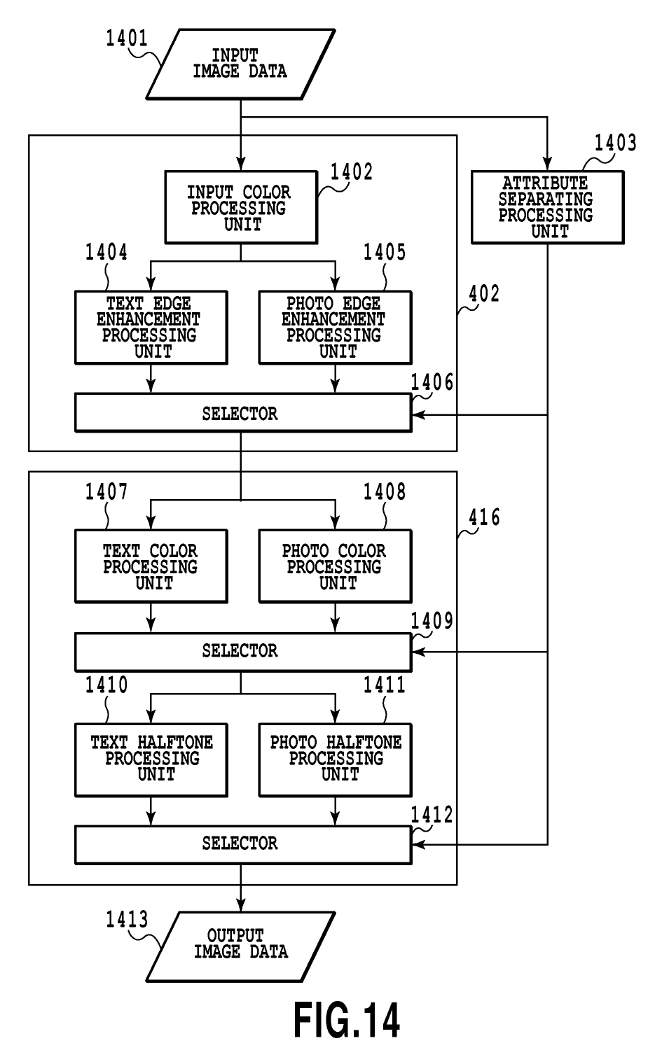

FIG. 14 is a block diagram illustrating an exemplary configuration of an image processing device.

Input image data 1401 received as input from a scanner not shown in the drawings is subsequently input into an input color processing unit 1402 and an attribute separating processing unit 1403 provided in the input image processing unit 402. In the input color processing unit 1402, the input image data 1401 subjected to various image processing such as tone correction and color space conversion processing. The post-image processing image data in the input color processing unit 1402 is then input into a text edge enhancement processing unit 1404 and a photo edge enhancement processing unit 1405. The text edge enhancement processing unit 1404 performs text edge enhancement processing with respect to the entirety of the input image data. In addition, photo (i.e., non-text) edge enhancement processing unit 1405 performs photo edge enhancement processing with respect to the entire of the input image data. After having been subjected to edge enhancement processing, the two sets of image data are subsequently input into the selector 1406.

On the basis of attribute data received as input from the attribute separating processing unit 1403, the selector 1406 selects which information to adopt from the two sets of image data on a per-pixel basis. The single set of image data obtained as a result of the above selections is then output to the output image processing unit 416.

In other words, when the attribute data for a given pixel indicates text attributes, the selector 1406 outputs the pixel value of the given pixel that was contained in the image data received as input from the photo edge enhancement processing unit 1405.

On the other hand, when the attribute data for a given pixel indicates photo attributes, the selector 1406 outputs the pixel value of the given pixel that was contained in the image data received as input from the text edge enhancement processing unit 1404.

The selector 1406 may also perform a well-known image processing such as background subtraction and logarithmic conversion.

In the above configuration, there are provided two components for edge enhancement (i.e., the text edge enhancement processing unit 1404 and the photo edge enhancement processing unit 1405), as well as a selector 1406. However, the present embodiment is not limited to the above configuration. For example, instead of the above three components, an image processing device may also be configured having a single edge enhancement processing unit. In this case, the edge enhancement processing unit may receive attribute data from the attribute separating processing unit 1403 and then switch between filter coefficients for edge enhancement on the basis of the received attribute data.

Subsequently, the text color processing unit 1407 and the photo color processing unit 1408 in the output image processing unit 416 respectively perform color processing for text and color processing for photos with respect to the image data received as input. For an image processing device connected to a print engine having CMYK inks as in the present embodiment, the text color processing unit 1407 may perform color processing that emphasizes text reproduction, wherein the print engine prints black text using the single color K. Conversely, the photo color processing unit 1408 may perform color processing emphasizing photo reproduction. The two sets of color-processed data output from the text color processing unit 1407 and the photo color processing unit 1408 are then respectively input into the selector 1409. On the basis of per-pixel attribute data generated by the attribute separating processing unit 1403, the selector 1409 then selects either the text color-processed image data or the photo color-processed image data on a per-pixel basis, thereby generating a single set of color-processed data on the basis of the selection results. Similarly to the edge enhancement processing units, the color processing units may also be configured as a single unit combining the text color processing unit 1407, the photo color processing unit 1408, and the selector 1409. In this case, the color processing unit may appropriately select coefficients in accordance with the attribute data and then perform color processing.

The color-processed data generated by the selector 1409 is subsequently input into the text halftone processing unit 1410 and the photo halftone processing unit 1411, and halftone processing is respectively performed. The text halftone processing unit 1110 emphasizes text reproduction, and performs error diffusion processing or high screen ruling dither processing, for example. Conversely, the photo halftone processing unit 1411 emphasizes smooth and stable gradient reproduction for photos, and performs low screen ruling dither processing or similar halftone processing.

The two sets of halftone data output from the text halftone processing unit 1410 and the photo halftone processing unit 1411 are respectively input into the selector 1412. Subsequently, on the basis of the attribute data, the selector 1412 selects one of the two sets of halftone data on a per-pixel basis, thereby generating a single set of halftone data. Similarly to the edge enhancement processing units 1404 and 1405, the halftone processing units 1410 and 1411 may also be configured as a single halftone processing unit combining the text halftone processing unit 1410, the photo halftone processing unit 1411, and the selector 1412. In this case, the halftone processing unit performs halftone processing by appropriately selecting coefficients in accordance with the attribute data.

The single set of halftone data generated by the selector 1412 is then output to the print engine as output image data 1413, and then processed for printing by the print engine.

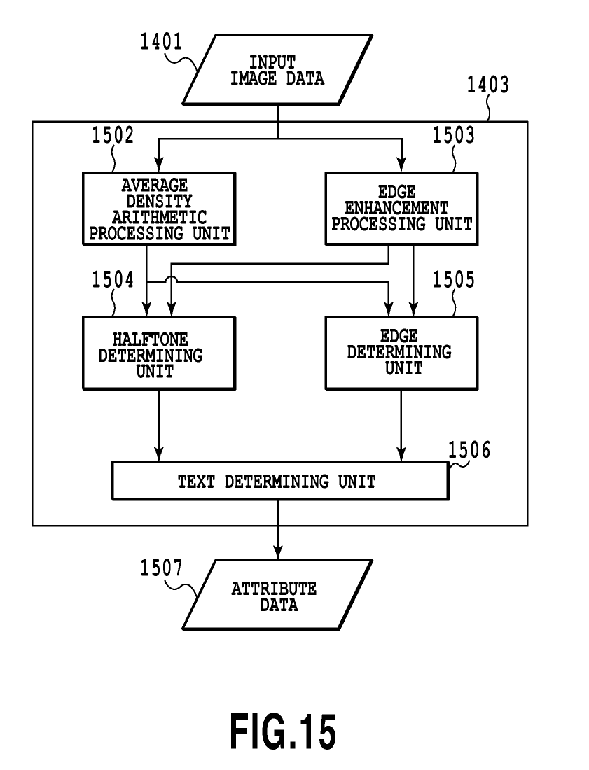

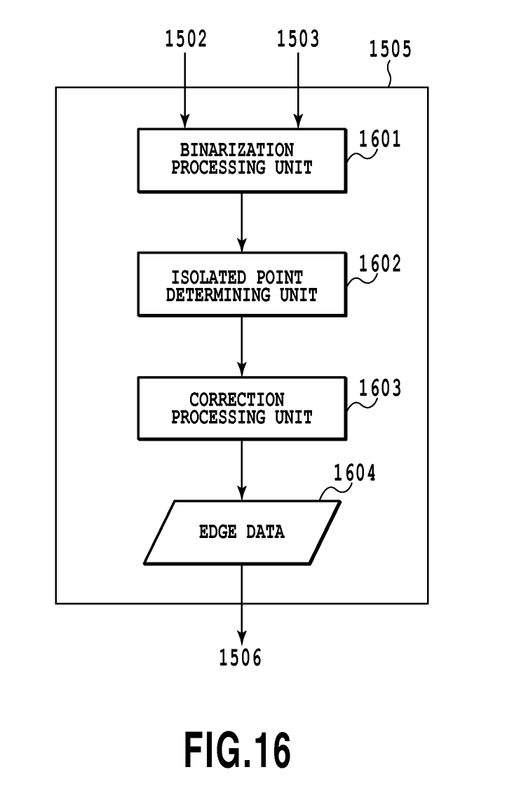

An example of the attribute separating processing unit 1403 described with reference to FIG. 14 will now be described with reference to FIGS. 15 and 16.

Input image data 1401 is input into the attribute separating processing unit 1403, whereby attribute data 1507 is generated. The processing of the attribute separating processing unit 1403 will now be described. The input image data 1401 is first input into an average density arithmetic processing unit 1502 and an edge enhancement processing unit 1503. The average density arithmetic processing unit 1502 computes the average density of a plurality of pixels, such as a 25-pixel average density for a 5 pixel (vertical)×5 pixel (horizontal) region, for example.

The edge enhancement processing unit 1503 performs edge enhancement processing with respect to a 5 pixel (vertical)×5 pixel (horizontal) region, for example. At this point, the filter coefficients used for edge enhancement are preferably determined using a differential filter having spatial frequency characteristics for extracting predetermined edges. For example, since the attribute data in the present embodiment is described by way of example as being used to determine text portion after extracting halftone portions and text edge portions, the filter coefficients preferably have spatial frequency characteristics allowing for easy extraction of text edges and halftone edges. Herein, respectively independent filter coefficients are preferable, but the invention is not limited thereto.

The average density computed by the average density arithmetic processing unit 1502 and the edge-enhanced data output from the edge enhancement processing unit 1503 are respectively input into both a halftone determining unit 1504 and an edge determining unit 1505.

The halftone determining unit 1504 compares the average density data output from the average density arithmetic processing unit 1502 with the edge-enhanced data output from the edge enhancement processing unit 1503, and from the difference therebetween, determines whether or not halftone edges exist. Herein, since average density and the amount of edge enhancement are being compared, halftone edges are determined to exist or not by respectively multiplying the compared values by comparison correction coefficients, or alternatively, by applying an offset when comparing the difference therebetween. Subsequently, although not shown in the drawings, halftone regions are extracted by processing such as a well-known pattern matching processing for detecting halftone patterns, or a wel-known addition processing or thickening processing.

The edge determining unit 1505 will now be described with reference to FIG. 16. The edge determining unit 1505 inputs both the average density data output from the average density arithmetic processing unit 1502 and the edge-enhanced data output from the edge enhancement processing unit 1503 into a binarization processing unit 1601, whereby it is determined whether or not edges exist. Herein, in order to compare the average density data to the edge-enhanced data, the binarization processing unit 1601 may respectively multiply the data by correction coefficients, or alternatively, the binarization processing unit 1601 may apply an offset when comparing the difference therebetween. In so doing, the binarization processing unit 1601 determines whether or not edges exist.

Edge data generated by the binarization processing unit 1601 is then input into the isolated point determining unit 1602. The isolated point determining unit 1602 refers to the 5 pixel×5 pixel regions constituting the edge data, for example, and then determines whether or not the focus pixels form a continuous edge or an isolated point. If an edge is an isolated point, then the isolated point determining unit 1602 removes the edge or integrates the edge with another edge. The above processing is performed in order to reduce edge extraction determination errors due to noise.

The edge data from which isolated points have been removed by the isolated point determining unit 1602 is then input into the correction processing unit 1603. The correction processing unit 1603 performs correction processing to thicken edges and remove unevenness from lines by correcting notches or other features, thereby generating edge data 1604.

The halftone region data generated by the halftone determining unit 1504 and the edge data generated by the edge determining unit 1505 are then input into the text determining unit 1506. The text determining unit 1506 determines an individual pixel to be part of a text edge if, for example, the pixel is not in a halftone region and additionally part of an edge. In other words, the text determining unit 1506 determines text within a halftone region to be a halftone, while determining text outside a halftone region to be text. Alternatively, the text determining unit 1506 may determine an individual pixel to be part of a text edge in a halftone region if the pixel is in a halftone region and additionally part of an edge. Alternatively, the text determining unit 206 may determine an individual pixel to be part of a text edge if the pixel is not in a halftone region and additionally part of an edge. Since the above processing becomes part of the internal design specification of the image processing device, the particular processing to use may be determined on the basis of the specification.

The above thus describes the configuration of the image processing device shown in FIG. 14. According to the above image processing device, attribute data is obtained by using attribute separating processing, and then image processing is performed according to the attribute data. For example, photo regions may be processed for photos emphasizing color tone and gradation, while text regions may be processed for text emphasizing sharpness, thereby improving image quality in the reproduced image. Moreover, detecting the color components of an image and printing achromatic text or other regions using pure black allows for improvement of image quality.

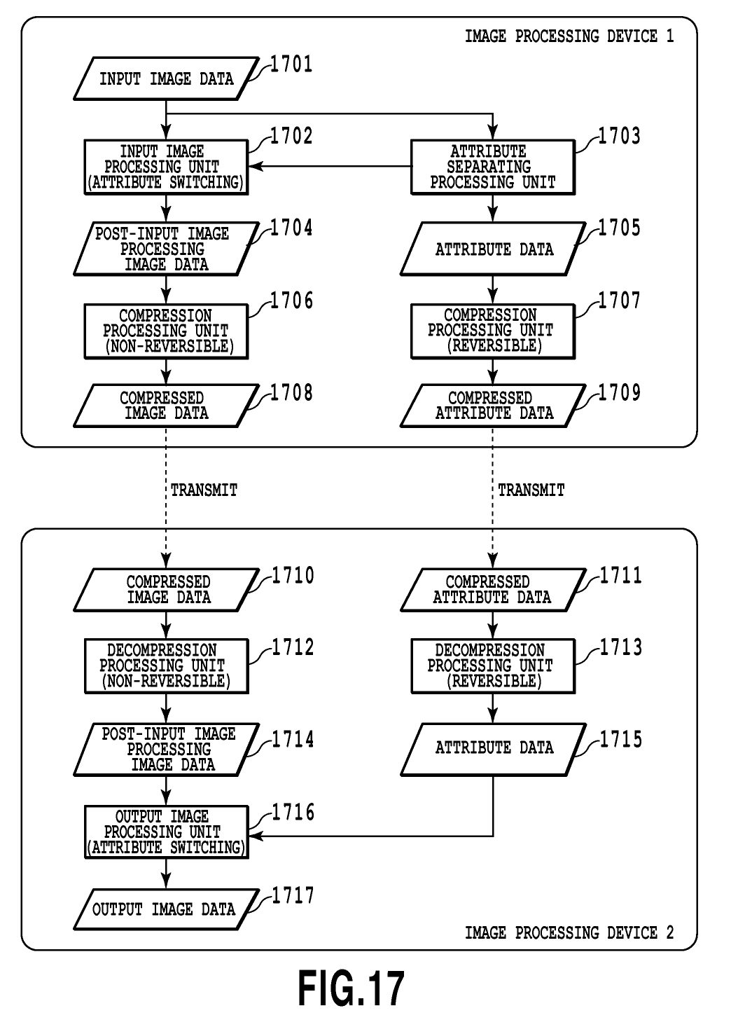

Meanwhile, when a plurality of image processing devices like the above are connected together, several problems arise. Such a configuration and problems will now be described with reference to FIG. 17.

FIG. 17 is a diagram illustrating an exemplary configuration whereby image reproduction is realized among a plurality image processing devices. An image processing device 1 performs input image processing and attribute separating processing (i.e., generates attribute data) with respect to input image data obtained from a scanner. After transmission, an image processing device 2 receiving this data performs output image processing.

First, the processing performed in the image processing device 1 will be described. Input image data 1701 received as input from a scanner is first input into an input image processing unit 1702 and an attribute separating processing unit 1703 as described above. (The attribute separating processing unit 1703 herein is similar to the attribute separating processing unit 1403 in FIG. 14.) The input image processing unit 1702 and the attribute separating processing unit 1703 perform the processing described with reference to FIG. 14.

However, the processing hereinafter differs from that described with reference to FIG. 14. In contrast to FIG. 14, the image processing device 1 in FIG. 17 transmits both the image data and the attribute data.

First, the post-input image processing image data 1704 (being identical to the image data output by the selector 1406 in FIG. 14) is sent to a compression processing unit 1706. In addition, the attribute data 1705 (i.e., the data output by the attribute separating processing unit 1403 in FIG. 14) is sent to a compression processing unit 1707. In this way, both the post-input image processing image data 1704 and the attribute data 1705 are compressed for transmission. The compression processing unit 1706 compresses the post-input image processing image data 1704 using a well-known non-reversible compression scheme such as JPEG, thereby generating compressed image data 1708. The compression processing unit 1707 compresses the attribute data 1705 using a well-known reversible compression scheme such as PackBits, thereby generating compressed attribute data 1709.

The image processing device 1 then transmits the compressed image data 1708 and the compressed attribute data 1709 to the image processing device 2. The image processing device 2 decompresses the received compressed image data 1710 and the compressed attribute data 1711 using the decompression processing unit 1712 and the decompression processing unit 1713, respectively. The decompressed post-input image processing image data 1714 and the decompressed attribute data 1715 is then input into an output image processing unit 1716 (equivalent to the output image processing unit 416 in FIG. 14). Subsequently, similarly to that shown in FIG. 14, the output image processing unit 1716 performs image processing on the basis of the attribute data 1715, thereby obtaining output image data 1717.

In this way, image data scanned at the image processing device 1 is transmitted to the image processing device 2 and then printed by a print engine connected to the image processing device 2. Even when performing image reproduction over a network in this way, output material is obtained that is equal in image quality to the reproduced image output from the image processing device 1. However, while the data size can be reduced by applying a non-reversible compression scheme such as JPEG to the image data, the data size increases because only a reversible compression scheme is applied to the attribute data. As a result, low disk space issues may occur on the transmitting image processing device 1 or the receiving image processing device 2. In particular, if the receiving device is unable to print immediately, it may be necessary to store the data for a long period of time, which can pose a significant problem.

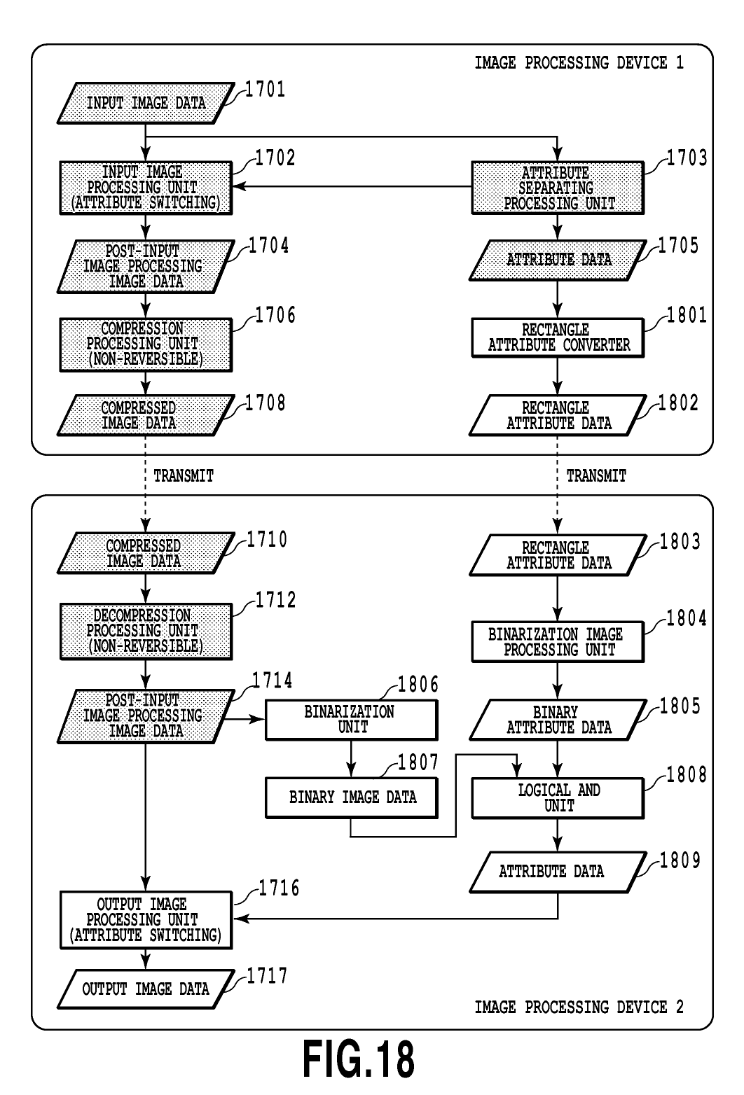

FIG. 18 is a diagram illustrating the configuration of a system able to resolve the above problem.

The processing configuration of the respective image processing devices shown in FIG. 18 are essentially similar to those shown in FIG. 17.

More specifically, the configuration of the processing components 1702, 1706, 1712, and 1703 are similar to those in FIG. 17. Consequently, the data 1701, 1704, 1704, 1708, 1710, and 1714 is also similar to that shown in FIG. 17. These similar portions are indicated in FIG. 18 by means of hatching.

The portions differing from FIG. 17 will now be described.

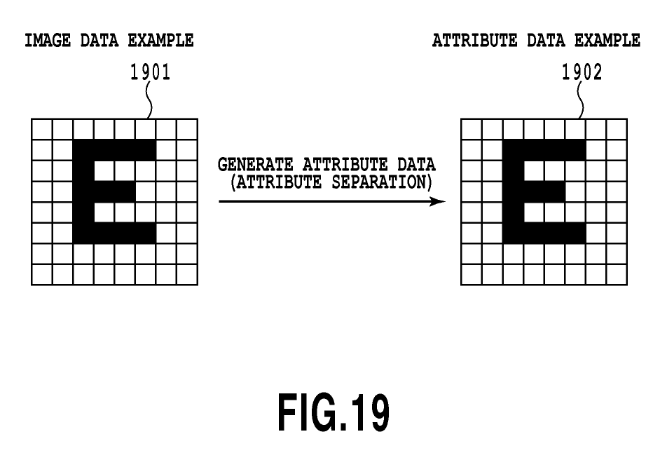

First, the attribute data 1705 generated by the attribute separating processing unit 1703 is input into a rectangle attribute converter 1801 and thereby converted into rectangle attribute data 1802. This rectangle attribute converter 1801 will now be described with reference to FIGS. 19, 20, and 21.

FIG. 19 illustrates an example of image data and attribute data. The image data example 1901 represents the character “E”, while the attribute data example 1902 is generated by the attribute separating processing unit 1703. In the present embodiment, the attribute data example 1902 has 1 bit per pixel. The attribute data example 1902 indicates text attributes when the attribute data value for a corresponding pixel is 1 (shown as black in FIG. 19), and indicates non-text attributes (for example, photo attributes) when the value is 0 (shown as white in FIG. 19).

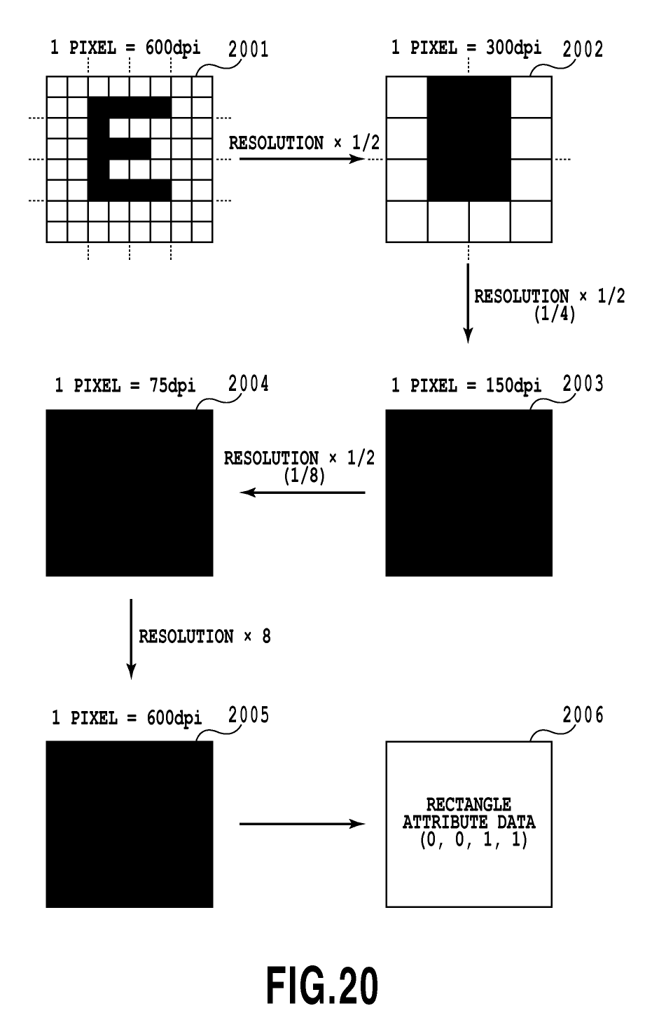

FIG. 20 illustrates an example of a method for converting the attribute data 1705 to the rectangle attribute data 1802 (i.e., the processing of the rectangle attribute converter 1801). In this processing, the resolution of the attribute data is decreased (i.e., a block of N×N pixels is converted into a single pixel). The rule for conversion can be stated as follows: when there exists at least one pixel with an attribute data value of 1 within the N×N block, the attribute data value of the single pixel after conversion is 1.

The above will now be described by taking the attribute data 1902 shown in FIG. 19 as an example. Consider the case wherein the attribute data example 1902 is expressed at a resolution of 600 dpi like that of the attribute data 2001 shown in FIG. 20. Following the above rule, if the resolution of the 600 dpi attribute data 2001 is halved to 300 dpi, then the 300 dpi attribute data 2002 is obtained. Furthermore, if the resolution of the 300 dpi attribute data 2002 is halved to 150 dpi, then the 150 dpi attribute data 2003 is obtained. Furthermore, if the resolution of the 150 dpi attribute data 2003 is halved to 75 dpi, then the 75 dpi attribute data 2004 is obtained. Finally, if the 75 dpi attribute data 2004 is converted back to the original 600 dpi resolution, then the 600 dpi attribute data 2005 is obtained. The coordinates of the 600 dpi attribute data 2005 are then converted to obtain the rectangle attribute data 2006. The (0, 0, 1, 1) shown in the rectangle attribute data 2006 indicates that the attribute data values are 1 for all pixels from the coordinates (0, 0) to the coordinates (1, 1).

Although the resolution is successively halved in the present method, the resolution is successively halved, the present invention is not limited thereto. Likewise, the number of times the resolution is decreased is also not limited to that described above. In addition, although the resolution was simply multiplied by a factor of 8 to restore the original resolution, the present invention is not limited to the above. Furthermore, in the present method, although the attribute data is converted into rectangle attribute data by converting the resolution thereof, the present invention is not limited thereto. For example, similar results can be realized by converting the 1-bit data into multi-bit data, applying smoothing processing using a spatial filter, and then performing binarization processing with respect to the smoothed attribute data. In addition, a technique for generating attribute data also exists wherein projections are taken in the main scan direction and the sub scan direction and then consolidated. In addition, labeling or similar techniques are also commonly used.

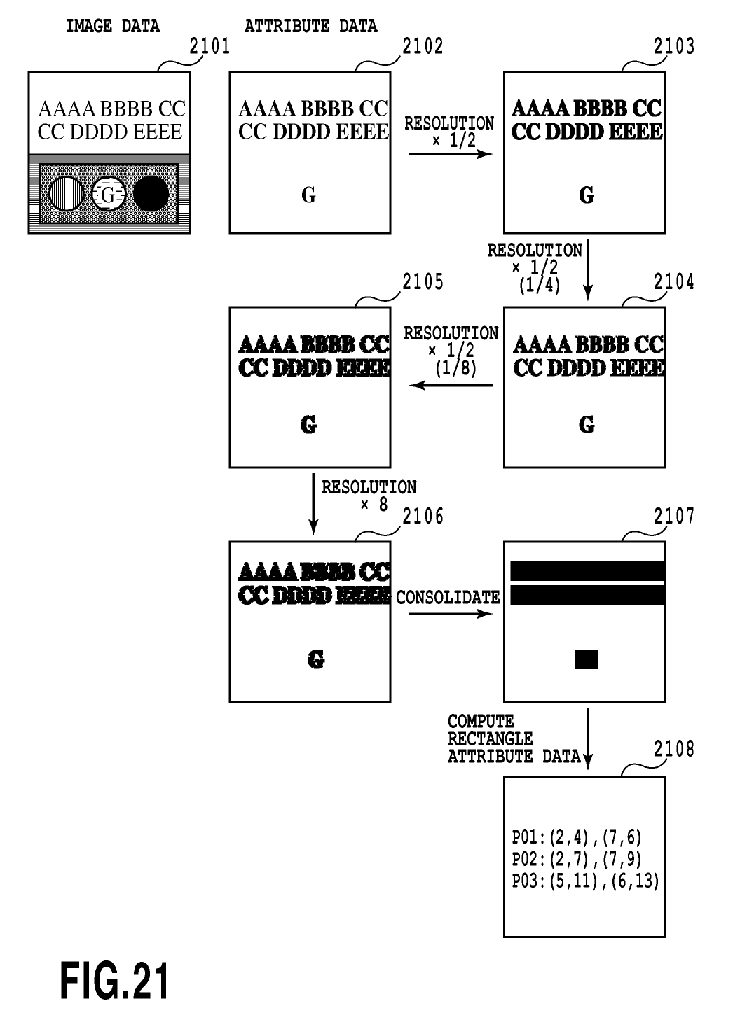

The above thus describes a method for the essential processing for converting attribute data into rectangle attribute data. An example wherein the above processing is applied to an actual image will now be described with reference to FIG. 21.

The image data example 2101 is an exemplary image made up of a text image (having a text attribute value of 1) and a graphical image (having a text attribute value of 0). The result of applying attribute separating processing to this image is indicated as the attribute data example 2102. This attribute data is then converted into rectangle attribute data using the method described with reference to FIG. 20. The resolution of the 600 dpi attribute data 2102 is halved to 300 dpi, thereby obtaining the 300 dpi attribute data 2103. In addition, the resolution of the 300 dpi attribute data 2103 is halved to 150 dpi, thereby obtaining the 150 dpi attribute data 2104. In addition, the resolution of the 150 dpi attribute data 2104 is halved to 75 dpi, thereby obtaining the 75 dpi attribute data 2105. Lastly, the 75 dpi attribute data 2105 is restored to the original resolution of 600 dpi, thereby obtaining the 600 dpi attribute 2106. In practice, at this point the attribute is subjected to consolidation processing that was omitted from the description with reference to FIG. 20, thereby converting the attribute data into the consolidated attribute data 2107. Subsequently, the coordinates of the rectangular portions are computed from the consolidated rectangle attribute data 2107, thereby obtaining the final rectangle attribute data 2108.

In this way, the rectangle attribute converter 1801 in FIG. 18 converts the attribute data 1705 into the rectangle attribute data 1802. Since the rectangle attribute data 1802 is obtained as a result of processing to decrease the resolution and then converted to coordinate information, the rectangle attribute data 1802 obviously has a much smaller data size than the attribute data 1705. Consequently, the rectangle attribute data 1802 can be efficiently transmitted. In addition, the possibility of low disk space issues occurring on the receiving device is also reduced. Needless to say, the rectangle attribute data 1802 may also be reversibly compressed before transmission. In this case, the image processing device 2 obviously decompresses the received, reversibly compressed rectangle attribute data, and then takes the decompressed data to be the rectangle attribute data 1803.

The compressed image data 1708 and the rectangle attribute data 1802 obtained as described above is transmitted from the image processing device 1 to the image processing device 2. The configuration of the image processing device 2 that receives the compressed image data 1708 and the rectangle attribute data 1802 will now be described with reference to FIG. 18.

Similarly to FIG. 17, the received compressed image data 1710 is decompressed by the decompression processing unit 1712, thereby obtaining post-input image processing image data 1714 as a result. The post-input image processing image data 1714 is then input into the binarization unit 1806. The binarization unit 1806 converts the input post-input image processing image data 1714 into binary image data 1807.

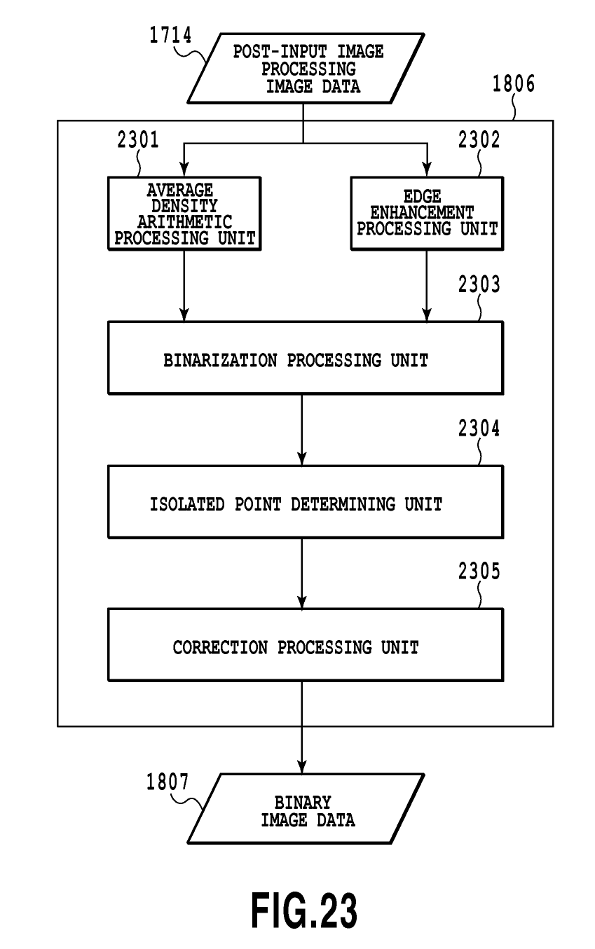

An exemplary binarization unit 1806 is shown in FIG. 23, and will be described hereinafter.

First, the post-input image processing image data 1714 is input into the average density arithmetic processing unit 2301 and the edge enhancement processing unit 2302. The average density arithmetic processing unit 2301 and the edge enhancement processing unit 2302 perform processing identical to that of the average density arithmetic processing unit 1502 and the edge enhancement processing unit 1503 in FIG. 15. Subsequently, average density data and edge-enhanced data is input into the binarization processing unit 2303 from the average density arithmetic processing unit 2301 and the edge enhancement processing unit 2302.

By performing processing similar to that of the binarization processing unit 1601, the binarization processing unit 2303 determines whether or not each pixel is part of an edge, thereby generating edge data. Furthermore, the isolated point determining unit 2304 removes isolated points from this edge data, similarly to the isolated point determining unit 1602. In addition, the correction processing unit 2305 performs correction processing to thicken edges and remove unevenness from lines by correcting notches or other features with respect to the edge data from which isolated points were removed, thereby generating the binary image data 1807.

Meanwhile, the received rectangle attribute data 1803 is converted into binary attribute data 1805 by the binarization image processing unit 1804. In the present embodiment, since the rectangle attribute data 1803 is the coordinate information of the already binary rectangle attribute data, the rectangle attribute data 1803 naturally becomes binary data when converted into image data by the binarization image processing unit 1804. In the present embodiment, this binary data is referred to as binary attribute data 1805.

The binary image data 1807 and the binary attribute data 1805 obtained in this way is input into the logical AND unit 1808. The logical AND unit 1808 performs logical AND processing with respect to each individual pixel, thereby obtaining the attribute data 1809 as a result. In addition, on the basis of the obtained attribute data 1809, the output image processing unit 1716 performs output image processing with respect to the post-input image processing image data 1714, thereby obtaining the output image data 1717. The processing performed by the output image processing unit 1716 in FIG. 18 is similar to that of the output image processing unit 416 in FIG. 14. In addition, the processing of the binarization unit 1806 may also be performed with respect to only the regions in the rectangle attribute data 1803 having certain desired attributes.

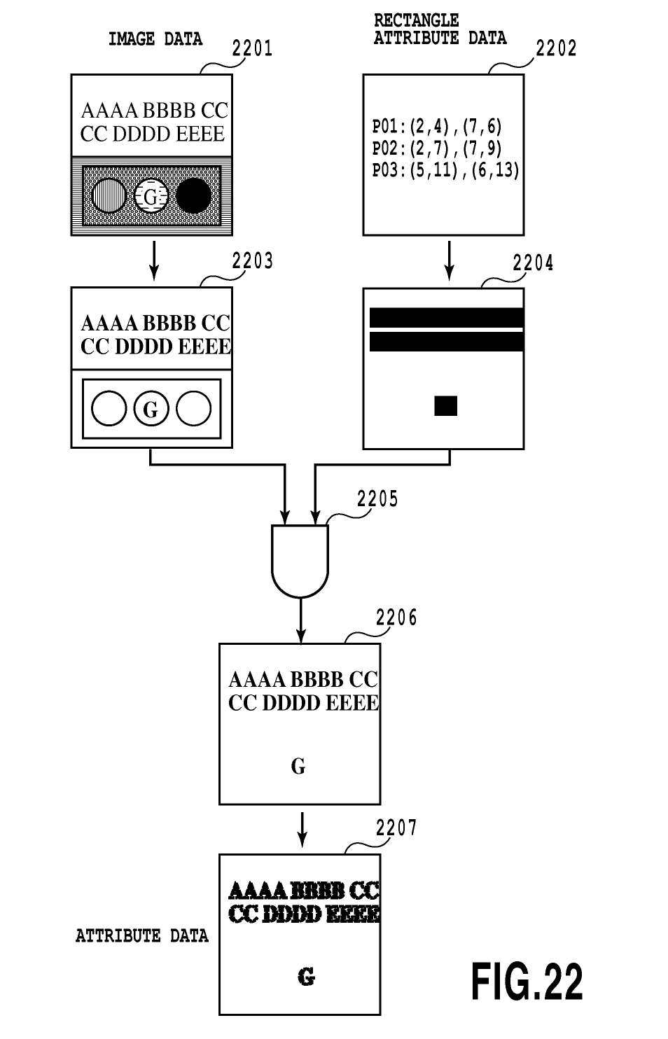

A specific example of restoring the above attribute data will now be described using an actual image and with reference to FIG. 22. The exemplary image data 2201 shown in FIG. 22 is an image equivalent to the post-input image processing image data 1714 described with reference to FIG. 18. The rectangle attribute data 2202 is equivalent to the rectangle attribute data 1803.

The image data 2201 is first converted into binary image data 2203 by the binarization unit 1806. Herein, text candidates are expressed by the value 1 in the binarization results. Otherwise, a value of 0 is output. For the sake of convenience, the value 1 is shown as black and the value 0 is shown as white in FIG. 22. In the case of a color image, a single-channel luminance signal may be generated from the color signals of a plurality of channels and then binarized, or binarization processing may be performed after configuring per-channel threshold values. The value of the binary image data may be taken to 1 when a text candidate appears in any one of the binary results output from each channel, when the same text candidate appears in all channels, or the value may be determined by majority or other processing.

Meanwhile, the rectangle attribute data 2202 is converted into the binary attribute data 2204 by the binarization image processing unit 1804. At this point, the binarization image processing unit 1804 refers to information such as the image size and resolution of the image data 2201, and then converts the coordinate data of the rectangle attribute data 2202 into image data, thereby obtaining the binary attribute data 2204. At this point, since the pixels expressed by the rectangle attributes are originally text regions, the binarization processing unit image interprets such regions as text candidates and sets the value thereof to 1. Otherwise, a value of 0 is output. For the sake of convenience, the value 1 is shown as black and the value 0 is shown as white in FIG. 22.

The binary image data 2203 and the binary attribute data 2204 are then input into the logical AND unit 2205 (which is identical to the logical AND unit 1808 in FIG. 18). In the logical AND unit 2205, when a pixel from the binary image data 2203 and a corresponding pixel from the binary attribute data 2204 are both 1 (shown as black in FIG. 22), then a value of 1 (shown as black in FIG. 22) is output. The above is performed with respect to all pixels, thereby obtaining the attribute data 2206. Although not shown in FIG. 22, it is also preferable to perform simple correction processing to thicken edges and remove unevenness from lines by correcting notches or other features with respect to the obtained attribute data 2206. As a result of the correction processing, the attribute data 2207 is obtained.

In this way, in the present embodiment, attribute data in the transmitting image processing device 1 is not sent as-is, but instead first converted into rectangle attribute data. Subsequently, the attribute data is restored from the rectangle attribute data.

In so doing, it becomes possible to avoid low disk space issues that may occur when sending and receiving.

In addition, in the present embodiment, the logical AND unit 1808 in FIG. 18 uses not only the rectangle attribute data 1803, but also the post-input image processing image data 1714 when restoring the attribute data from the rectangle attribute data 1803. By additionally using the post-input image processing image data 1714 in this way, the original attribute data 1705 can be accurately restored.

Furthermore, by realizing accurate restoration, it becomes possible to output image data from a print engine as output image data that is nearly identical to that obtained when image processing is performed by a single image processing device using attribute data as shown in FIG. 14 (i.e., when it is not necessary to reduce to the data size of the attribute data for transmission).

In addition, in the present embodiment, when restoring the attribute data at the receiving image processing device 2, the binarization processing performed when generating the attribute data at the transmitting image processing device 1 was used. However, simpler binarization processing may also be performed.

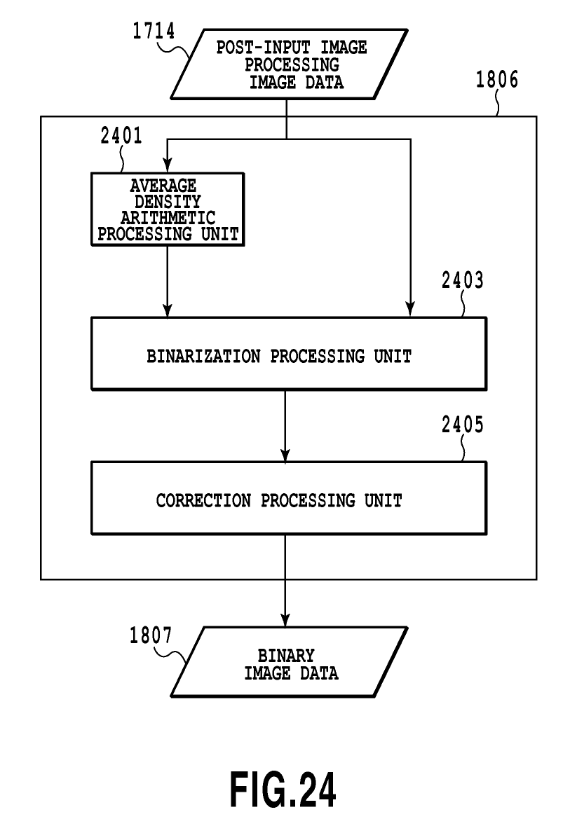

An example of such processing is shown in FIG. 24. The post-input image processing image data 1714 is first input into the average density arithmetic processing unit 2401 and the binarization processing unit 2403. The average density arithmetic processing unit 2401 computes the average density of a plurality of pixels, such as a 25-pixel average density for a 5 pixel (vertical)×5 pixel (horizontal) region, for example. The computed average density data is the input into the binarization processing unit 2403. In the binarization processing unit 2403, binarization processing is performed with respect to the pixels in the post-input image processing image data 1714, wherein the corresponding average density data computed by the average density arithmetic processing unit 2401 is taken to be the threshold value. Herein, since it is desirable to extract text portions as attribute data, threshold processing may be performed with respect to a luminance signal or a brilliance signal. The processing may output a value of 1 when the image data is smaller than the threshold value, and output a value of 0 when this is not the case. The data output from the binarization processing unit 2403 is input into the correction processing unit 2405, where correction processing is performed to thicken edges and remove unevenness from lines by correcting notches or other features, thereby obtaining the binary image data 1807.

The processing of the binarization unit 1806 may also be performed with respect to only the regions in the rectangle attribute data 1803 having certain desired attributes.

As described above, by performing binarization processing with respect to image data using average density as the threshold value and without performing edge enhancement processing, a binary image can be generated by a simple configuration. In the present embodiment, correction processing is performed after the binarization processing. However, the binary image data generated herein is the result of taking the logical product (i.e., an AND operation) with respect to binary attribute data, and thus correction processing is not necessary in the case where correction is performed after taking the logical product. In so doing, the processing is made simpler, and it becomes possible to restore attribute data at high speeds. In addition, such processing is possible not only by means of hardware, but also by means of software.

As described above, when restoring the attribute data at the receiving image processing device 2, binarization processing is performed using image data and average density data for the surrounding pixels thereof. However, it is also possible to perform simpler binarization processing.

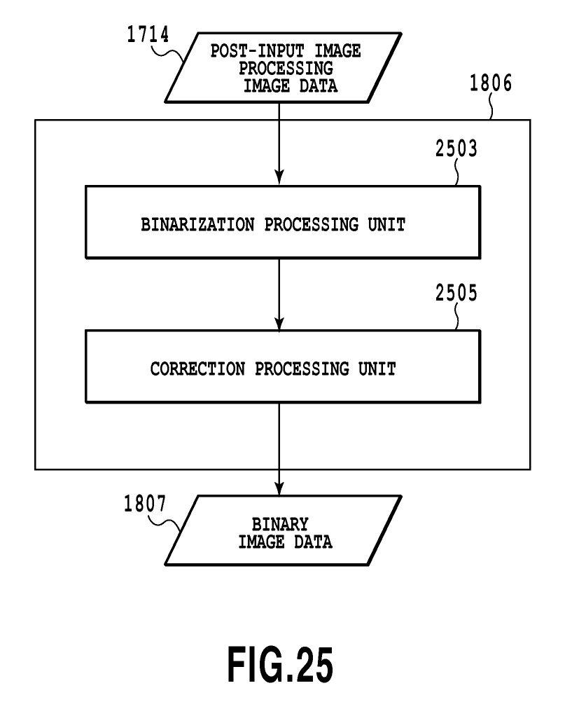

An example of such processing is shown in FIG. 25. The post-input image processing image data 1714 is first input into the binarization processing unit 2503. The binarization processing unit 2503 performs binarization processing with respect to the post-input image processing image data 1714 using a fixed threshold value. The fixed threshold value is configured as follows. First, the threshold value determined for use in the binarization processing at the transmitting device is embedded into header or tag information in the image data and then sent to the receiving device. The receiving device reads this threshold value and then set this value as the threshold value of the binarization processing unit 2503. Alternatively, a threshold value computed and determined from a luminance signal to be processed as text may also be used. Herein, since it is desirable to extract text portions as attribute data, threshold processing may be performed with respect to a luminance signal or a brilliance signal. The processing may output a value of 1 when the image data is smaller than the threshold value, and output a value of 0 when this is not the case. The data output from the binarization processing unit 2503 is input into the correction processing unit 2505, where correction processing is performed to thicken edges and remove unevenness from lines by correcting notches or other features, thereby obtaining the binary image data 1807.

The processing of the binarization unit 1806 may also be performed with respect to only the regions in the rectangle attribute data 1803 having certain desired attributes.

As described above, by performing binarization processing using a fixed threshold value without computing a threshold value for the binarization processing, a binary image is generated with a simple configuration. In addition, by using the threshold value determined as part of the processing at the transmitting device, it is possible to obtain similar advantages. Since text candidate portions are extracted from the rectangle attribute data, excellent advantages can be obtained even with simple processing like that of the present embodiment. In the present embodiment, correction processing is performed after the binarization processing. However, the binary image data generated herein is the result of taking the logical product (i.e., an AND operation) with respect to binary attribute data, and thus correction processing is not necessary in the case where correction is performed after taking the logical product. In so doing, the processing is made simpler, and it becomes possible to restore attribute data at high speeds. In addition, such processing is possible not only by means of hardware, but also by means of software.

Although the present embodiment discloses an image processing device, it should appreciated that the foregoing may obviously also be realized as a computer-readable program for performing the processing described above on an image processing device or a computer. In addition, the foregoing may obviously also be realized as a computer-readable storage medium that stores such a program.

In addition, in the foregoing embodiment, the per-pixel attribute information indicates per-pixel characteristics. While image data is made up of a collection of pixels and includes luminance (or density) information for each pixel therein, attribute data is made up of a collection of pixels and includes information regarding the characteristics of each pixel. This information indicating the characteristics of each pixel does not include information indicating information indicating the luminance or darkness of pixels, such as luminance information or density information. Obviously, information indicating color is also not included. Rather, all pixel-related information other than the above is attribute information for expressing per-pixel characteristics. In the foregoing embodiment, information that indicates whether or not respective pixels are included in a text region was given as a specific example of attribute information, and a method for reducing the information volume of such attribute information was disclosed. However, as has been repeatedly stated, the attribute information referred to in the present embodiment is information that indicates pixel characteristics, and for this reason is not limited to information indicating whether or not respective pixels are included in a text region. For example, the attribute information referred to in the foregoing embodiment obviously also includes information indicating whether or not respective pixels are included in an edge region. In addition, the attribute information referred to in the present embodiment obviously also includes information indicating whether or not respective pixels are included in a halftone region.

### Other Embodiments

The present invention may also be achieved by loading a recording medium, upon which is recorded software program code for realizing the functions of the embodiment described above, into a system or device, and then having the computer of the system or other device read and perform the program code from the recording medium. The recording medium herein is a computer-readable recording medium. In this case, the program code itself that is read from the recording medium realizes the functions of the embodiment described above, and thus the recording medium upon which the program code is stored constitutes the present invention. In addition, on the basis of instructions from the program code, an operating system (OS) or other software operating on the computer may perform all or part of the actual processing, thereby realizing the functions of the embodiment described above as a result of such processing. In addition, the program code read from the recording medium may be first written into a functional expansion card or functional expansion unit of the computer, wherein the embodiment described above is realized as a result of the functional expansion card or similar means performing all or part of the processing on the basis of instructions from the program code.

While the present invention has been discussed with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2008-133438, filed May 21, 2008, and 2007-277586, filed Oct. 25, 2007, all of which are hereby incorporated by reference herein in their entirety.

What is claimed is:

1. An image processing device, comprising:
an attribute separating component configured to extract attribute data from image data;
a vectorization processing component configured to perform vectorization for the attribute data extracted by the attribute separating component; and
a transmitting component configured to transmit, to another device, vectorized attribute data that has been vectorized by the vectorization processing component together with the image data.

2. The image processing device of claim 1, wherein the transmitting component performs non-reversible compression for the image data before transmission, and transmits the vectorized attribute data without performing non-reversible compression for the vectorized attribute data.

3. The image processing device of claim 2, wherein the other device performs image processing for the transmitted image data using the transmitted vectorized attribute data.

4. The image processing device of claim 3, wherein the other device converts the vectorized attribute data into the original attribute data before performing image processing.

5. The image processing device of claim 3, wherein the other device performs image processing using the vectorized attribute data as-is.

6. The image processing device of claim 1, wherein the attribute data is attribute data indicating text or image.

7. The image processing device of claim 1, wherein the transmitted image data is subjected to image processing using attribute data before the attribute data is vectorized.

8. An image processing device, comprising:
an attribute separating component configured to generate attribute data from input image data;
an input image processing component configured to adaptively process input image data on the basis of attribute data generated by the attribute separating component; and
a vectorization processing component configured to perform vectorization for the attribute data generated by the attribute separating component;
wherein, when generating a file for transmission and attribute data of the file using post-input image processing image data generated by the input image processing component and vectorized attribute data generated by the vectorization processing component, the attributes of the vectorized attribute data are preferentially taken to be the attribute data for the file for transmission.

9. The image processing device of claim 8, wherein, when generating the attribute data of the file for transmission, the post-input image processing image data has image attributes, and the vectorized attribute data has vector attribute or text attribute.

10. An image processing device, comprising:
a receiving component configured to receive image data and vectorized attribute data obtained by performing vectorization for original attribute data; and
a raster image processor configured to restore attribute data from the vectorized attribute data in order to accurately restore the vectorized attribute data.

11. An image processing method, comprising the steps of:
separating attribute by extracting attribute data from image data;
vectorizing the attribute data extracted in the separating step; and
transmitting, to another device, the vectorized attribute data vectorized in the vectorizing step together with image data.

12. The image processing method of claim 11, wherein the other device performs image processing for the transmitted image data using the transmitted vectorized attribute data.

13. The image processing method of claim 12, wherein the other device converts the vectorized attribute data into the original attribute data before performing image processing.

14. The image processing method of claim 12, wherein the other device performs image processing using the vectorized attribute data as-is.

15. The image processing method of claim 11, wherein the attribute data is attribute data indicating text or image.

16. The image processing method of claim 11, wherein the transmitted image data is subjected to image processing using attribute data before the attribute data is vectorized.

17. An image processing method, comprising the steps of:
separating attribute by generating attribute data from input image data;
adaptively processing the input image data on the basis of attribute data generated in the separating step; and
vectorizing the attribute data generated in the separating step;
wherein, when generating a file for transmission and attribute data of the file using post-input image processing image data processed in the processing step and vectorized attribute data generated in the vectorizing step, the attribute of the vectorized attribute data are preferentially taken to be the attribute data for the file for transmission.

18. The image processing method of claim 17, wherein, when generating the attribute data of the file for transmission, the post-input image processing image data has image attributes, and the vectorized attribute data has vector attributes or text attributes.

19. An image processing method, comprising the steps of:
receiving image data and vectorized attribute data obtained by performing vectorization for original attribute data; and
raster image processing to restore attribute from the vectorized attribute data in order to accurately restore the vectorized attribute data.

20. A computer-readable recording medium having computer-executable instructions for performing a method, the method comprising the steps of:
extracting attribute data from image data;
vectorizing the extracted attribute data; and
transmitting, to another device, the vectorized attribute data together with the image data.

21. An image processing device, comprising:
a receiving component configured to receive image data and attribute data of reduced data size that was obtained from original attribute data; and
a logical product component configured to take the logical product between the image data and the attribute data of reduced data size in order to restore the original attribute data.
